(19) United States
(12) Patent Application Publication
(10) Pub. No.: US 2025/0238347 A1
(43) Pub. Date: Jul. 24, 2025

(54) METHOD AND APPARATUS OF MONITORING AND MANAGING A GENERATIVE AI SYSTEM

(71) Applicant: PRICEWATERHOUSECOOPERS LLP, Toronto (CA)

(72) Inventors: Bahar SATELI, Montreal (CA); Vik PANT, Toronto (CA)

(21) Appl. No.: 19/026,975

(22) Filed: Jan. 17, 2025

(30) Foreign Application Priority Data
Jan. 18, 2024 (CA) 3226517

(51) Int. Cl. G06F 11/3668; G06F 9/451; G06F 11/34

(52) U.S. Cl. CPC G06F 11/3668; G06F 9/451; G06F 11/3409

(57) ABSTRACT

A computer system may have one or computers and one or more data storage devices storing instructions, which when executed by the one or more computers implements a characterization manager, comprising: a test data database storing a plurality of test data sets; the characterization manager configured for selecting one or more test data sets from the test data database and apply the selected test data sets to a Generative AI system to derive from the Generative AI system an output; an output analyzer for processing the output to generate characterization data describing one or more facets of the output.

### FIELD OF THE INVENTION

The present invention relates to the supervision and management of a generative AI system, encompassing novel mechanisms that revolve around content monitoring to enable a characterization of the generative AI system's output. This characterization process is helpful in spotting potential bias, unrelatedness, and other undesirable tendencies that may be present in the generated output. Moreover, the invention includes additional mechanisms aimed at effectively communicating and reporting this characterization to the end user. These reporting mechanisms play a role in enhancing transparency and user understanding regarding the quality and reliability of the generative AI system's output.

Furthermore, the invention encompasses supplementary mechanisms geared towards managing the generative AI system, aimed at influencing its behavior. These management mechanisms are helpful to avert undesirable tendencies within the system's output or align the output more closely with specific preferences. By implementing these supplementary management mechanisms, the invention enhances the adaptability and responsiveness of the generative AI system, enhancing its performance to cater to diverse user requirements and ensuring a more refined and tailored user experience.

### BACKGROUND OF THE INVENTION

Generative AI systems offer numerous economic benefits that contribute to enhanced productivity, efficiency, and innovation across various industries. These systems can automate and optimize processes, leading to cost savings and increased output. For instance, in content creation and marketing, generative AI can generate personalized advertisements, product descriptions, or social media content at scale, reducing the time and resources required for manual content production. In manufacturing, generative AI can assist in designing and optimizing complex products, leading to improved efficiency and reduced material waste. Furthermore, generative AI systems can facilitate data analysis and decision-making by quickly generating insights from vast amounts of information, enabling businesses to make data-driven decisions with greater speed and accuracy. Overall, the adoption of generative AI systems has the potential to drive economic growth, foster innovation, and create new opportunities in diverse sectors.

Generative AI systems also come with inherent risks that need to be addressed for their responsible and ethical use. One significant risk is the potential for bias and discrimination in the generated outputs. If the training data contains biases or if the AI system learns from biased human interactions, it can inadvertently perpetuate and amplify those biases, leading to unfair or discriminatory outcomes. Another risk is the generation of misleading or false information, known as “hallucinations”. Generative AI systems can produce seemingly authentic text, images, or videos, which may be exploited for spreading misinformation, fake news, or deepfakes, thereby undermining trust and integrity. Privacy concerns arise as generative AI systems can inadvertently disclose sensitive information, especially if they are trained on personal or confidential data. There are also ethical concerns surrounding the potential misuse of generative AI for malicious purposes, such as generating malicious content, impersonating individuals, or creating deceptive social engineering attacks. Additionally, the deployment of generative AI systems raises questions about accountability and responsibility, as it can be challenging to attribute generated content to a specific source or entity. Addressing these risks requires ongoing research, responsible development practices, robust regulation, and transparency in the deployment and use of generative AI systems.

### SUMMARY OF THE INVENTION

The invention pertains to a computer-implemented system and method designed for monitoring the content produced by a generative AI system. This system and method serve various purposes, including but not limited to monitoring compliance with acceptability standards or benchmarks. It provides a means to assess and evaluate the generated content to ensure it meets desired criteria or predefined expectations. The monitoring system and method can be applied in diverse contexts and offers potential applications beyond just assessing acceptability, enhancing the overall control and evaluation of the output generated by generative AI systems.

In a particular implementation scenario, the monitoring system is designed to provide a characterization of the generated content and optionally, assign a score based on a certain metric. This scoring mechanism aims to provide end-users with valuable insights into the behavior of the generative system, enabling them to assess its performance.

Characterization refers to the process of describing or depicting the distinctive qualities, traits, attributes, or features of the output of the generative AI system. Specifically, characterization can refer to the analysis, classification, or categorization of the output based on its defining qualities or attributes.

Generative AI systems exhibit a remarkable degree of flexibility when it comes to producing tailored output. These systems have the ability to generate content that can be specifically customized to meet the preferences, requirements, or specifications of individual users or applications. By providing appropriate prompts, instructions, or constraints, generative AI systems can produce output that aligns with desired styles, tones, or themes. For example, in the field of creative writing, these systems can generate stories, poems, or dialogues tailored to a particular genre or mood. In design and artistic applications, generative AI systems can generate visuals, logos, or illustrations with specific visual styles or characteristics. This flexibility allows generative AI systems to adapt and cater to a wide range of creative, informational, or communicative needs, making them highly versatile tools in various domains.

The ability to characterize the output of a generative AI system provides an important benefit as it enables the evaluation of its compliance with specific metrics, standards, or benchmarks. For instance, consider a hypothetical scenario involving a banking institution that deploys an automated chatbot on its website. The manner in which the chatbot interacts with clients becomes important as it should align with the organization's values and culture. Essentially, the chatbot's responses should reflect the banking institution's brand. Hence, it holds significance to exercise moderation or control over the output of the chatbot to prevent substantial deviation from the organization's brand guidelines. This includes avoiding offensive content, gender or racial bias, tones that are incongruous with a financial context, and any other unwanted behaviors. By monitoring and moderating the chatbot's output, the organization can ensure consistency and alignment with its desired brand image, fostering a positive user experience while upholding ethical and appropriate communication standards.

Desirable or acceptable behavior from a generative AI system can vary significantly depending on the specific preferences and requirements of different end-users. A religious institution, for instance, may seek to bias the output of the generative AI system to reflect a religious tone in the generated content, be it text, images, or audio, such that these mediums positively convey religious themes. On the other hand, a non-religious organization like a government institution that explicitly prohibits religious symbols may have contrasting needs. In their case, it becomes necessary to ensure that the generative AI system avoids any explicit or implied religious connotations to align with their specific requirements. The flexibility of generative AI systems allows for tailoring the behavior and output to meet the diverse expectations and sensitivities of different user contexts and organizations.

In a specific and non-limiting example of implementation, the invention provides a computer implemented system and method which is configured to receive the output generated by a generative AI system and process the output to perform a characterization thereof. The characterization describes or depicts one or more facets of the processed output. For example, one such facet can be a general assessment of performance, as perceived by the end-user. In other words, the facet reflects whether the end user would be satisfied with the response the user got from the system. Another facet could be the degree of avoidance of racial bias. Yet another facet could be the degree of avoidance of gender bias or other offensive content. Yet another facet could be associated with more subtle performance behavior, such as the tone, manner of speech and way of interacting with the user that reflect a particular brand or institutional values.

In a particular implementation example, the characterization of each facet incorporates the calculation of a score. In this scenario, the system generates a score for each facet, indicating the performance of the system in that particular area. These scores provide a quantitative assessment of how well the system performs in relation to each specific facet, offering a clear measure of its effectiveness or proficiency in different aspects, as instructed with prompts. Alternatively, the score can reflect a qualitative assessment of the specific facet, such as “compliant” vs “non-compliant”.

Another facet of the behavior of a generative AI system, which can be characterized and optionally scored, is adherence to regulatory mandates. As understanding of risks associated with generative AI systems deepens, governmental or other regulatory bodies might enforce restrictions or supervisions over these systems. Hence, a regulatory compliance facet serves as a measure of the extent to which the generative AI system aligns with specific standards, rules, or specifications.

If desired, the computerized system and method according to the invention may include a logging feature to document the characterization performed on one or more operational facets of the generative AI system. This creates a record that provides evidence of the system's characterization and the specific details of the process. In particular, it records the test inputs, the corresponding outputs generated in response to these inputs, and the derivation of the score associated with each facet's characterization.

In a specific example, the administrator of the generative AI system can receive the calculated scores through a user interface, which may take the form of a Graphical User Interface (GUI). The GUI can implement a dashboard which conveys scores in relation to a number of facets of the generative AI system that have been characterized.

In a possible variant, the GUI incorporates controls for managing the behavior of the generative AI system. With these controls, the administrator can initiate changes to the system's operation, adjusting its behavior across different facets. For example, the administrator can utilize the GUI to command modifications aimed at altering the tone of the generative AI system. For instance, during the holiday season, the administrator may choose to make the system output more cheerful, only to revert it back to a neutral tone outside of the holiday season. The GUI offers a convenient and intuitive platform for administrators to effectively monitor, dynamically fine-tune, and shape the behavior of the generative AI system in response to the generated scores.

Various mechanisms exist to influence the behavior of a generative AI system. Prompt engineering in generative AI systems like Generative Pre-Trained Transformers, is an example of those mechanisms. In response to inputs made by the administrator at the behavior controls of the GUI, the behavior of the generative AI system can be modified to align it with the administrator's inputs. The administrator can thus utilize the GUI for precise control over the behavior of the generative AI system for optimal results.

Prompt engineering refers to the deliberate and strategic construction of prompts to guide or influence the output generated by a generative AI system. It involves carefully crafting the initial input or instructions provided to the AI system in order to elicit desired responses or specific types of content.

Prompt engineering aims to optimize the output of the AI system by effectively conveying the desired task, style, or context to generate more accurate and relevant responses. This process involves considering various factors such as the length, specificity, and structure of the prompt, as well as the choice of vocabulary and phrasing used.

Generally, there are different techniques and strategies involved in prompt engineering:
1. Task Specification: Crafting prompts that explicitly specify the desired task or objective to guide the AI system towards generating output that aligns with the intended goal. For example, providing a clear instruction like “Re-write this sentence” when using a language model.
2. Conditioning: Incorporating specific instructions or constraints within the prompt to guide the AI system's behavior. This could involve specifying certain criteria or requirements for the generated content, such as generating a story with a specific plot twist or a poem with a particular rhyme scheme.
3. Context Setting: Providing relevant contextual information within the prompt to influence the AI system's understanding and response. This can involve giving background information, setting the tone or style, or referencing specific details to ensure the generated output is coherent and appropriate. For instance, in the case of a chatbot for an amusement park, the instruction could say “Speak like a clown” and the chatbot would adopt a tone and phraseology that would be consistent with how a clown would typically address the audience in a circus.
4. Bias Mitigation: Taking steps to mitigate biases in the prompt by carefully selecting wording, ensuring fairness, and avoiding potential stereotypes or discriminatory language that could influence the AI system's outputs.

In a specific example, prompt engineering involves embedding certain limits before the user can engage with the generative system, effectively pre-determining the AI system's behavior. With a chatbot, for example, prompt engineering pre-configures the chatbot such that it responds as intended when the user provides the input, which could be a question the user wants an answer to. From a practical standpoint, the user is kept unaware of this embedded constraint. However, in the AI system's viewpoint, both the embedded constraint and the user-submitted question are processed together and perceived as a single system prompt.

Prompt engineering, therefore, offers a dynamic and adaptable method for managing the behavior of a generative AI system. It allows for granular control at the level of individual user interactions. In other words, the embedded constraints like contextual parameters can be modified with each interaction cycle, providing a flexible approach to controlling system responses.

Prompt engineering, however, has limitations in terms of controlling system behavior and performance. A more fundamental way to adapt the model to certain use cases is to use transfer learning. The principle behind transfer learning is the thesis that the knowledge learned in one task can be applied to another related task. This can save a significant amount of time and resources as compared to training a model from scratch.

An example of transfer learning is model fine-tuning which makes permanent changes to the language model. In model fine-tuning a pre-trained model, which is a model that has been previously trained on a large-scale dataset, is adapted, or “fine-tuned” for a specific task.

In the context of a deep learning model, fine-tuning often involves keeping the early layers of the model fixed, while retraining the later layers. This is because the earlier layers typically capture generic features, while the later layers focus on the task-specific features.

By using model fine-tuning, one can leverage the powerful feature extraction capabilities of large pre-trained models for specific tasks even when they only have small amounts of training data.

In order to fine-tune a language model, the system administrator needs to generate training examples, which are processed to refine the model and thus adapt it to a specific use case. The fine-tuned model generally achieves better performance over the pre-trained model over a narrower range of tasks. Typically, each training example includes a single input prompt and the desired associated output or response. To achieve good performance over the pre-trained model, fine-tuning requires several hundreds or thousands high quality training examples. The increase in performance largely dependent on the number of training examples provided.

Transfer learning can also be applied to add a curated data set to fit the private content of the organization that is relevant to the use case and that the model should have access to during its operation.

Further attributes and variants of the invention will be provided in the detailed implementation example of the invention that follows.

### BRIEF DESCRIPTION OF THE DRAWINGS

FIG. 1 is a block diagram of a computer network architecture for the deployment of an LLM which services users.

FIG. 2 is a more detailed block diagram of the software stack executed by cloud servers to provide LLM services to end users.

FIG. 3 is a more detailed block diagram of the software functional blocks of the web service infrastructure of the business organization provided to manage LLM services.

FIG. 4 is a flow chart illustrating the typical interaction and data flow when an end-user makes an LLM service request.

FIG. 5 is a block diagram of a computer network architecture for the deployment of a LLM, similar to the one shown in FIG. 1, including a system for monitoring content generated by the LLM, according to one example of the invention.

FIG. 6 is a block diagram of an LLM content monitor, according to an example of implementation of the invention.

FIG. 7 is a more detailed block diagram of a characterization manager, which is a component of the LLM content monitor shown in FIG. 6, including a dashboard manager for managing a dashboard to convey the results of the characterization of the LLM.

FIG. 8 is a block diagram providing a high-level illustration of the process for performing a characterization of the generative AI system, using the LLM content monitor shown in FIG. 6.

FIG. 9 is an illustration of a Graphical User Interface allowing to specify the individual tests to be performed for characterizing the output of the generative AI system.

FIG. 10 is a flowchart describing the steps performed to assess the accuracy of the generative AI system by using a semantic coherence technique.

FIG. 11 is a block diagram of a variant of the characterization manager of FIG. 7, modified to enable input from human evaluators.

FIG. 12 is a depiction of a GUI instance structure, demonstrating the arrangement of visual elements and controls for conveying information to the human evaluator and receiving input from them.

FIG. 13 is a diagram illustrating the structure of a dashboard for reporting the results of the characterization of the LLM performed by the LLM characterization manager.

FIG. 14 is a block diagram of the content manager shown in FIG. 6, modified according to a variant which includes a prompt manager.

FIG. 15 is an illustration showing the mapping between the settings of a GUI control and prompts stored in a prompt database.

FIG. 16 is a flowchart of a process for extracting prompts based on user selection at a GUI control.

FIG. 17 is a block diagram illustrating conceptually the structure of a prompt database that is suitable for a range of different LLMs.

FIG. 18 is a block diagram of a system for enabling LLM services for users where the services are tailored to the specific user needs.

FIG. 19 is a flowchart which illustrates the operation of the system shown at FIG. 18.

FIG. 20 is a block diagram according to a variant of the system depicted in FIG. 18, where location-based data conditions the input prompt.

FIG. 21 is a block diagram illustrating a computer-based infrastructure for the sale and distribution of prompts for a Generative AI system, in particular system prompts, to end users.

FIG. 22 is a block diagram illustrating the high-level architecture of a digital marketplace system for prompts for a Generative AI system.

FIG. 23 is a more detailed block diagram of the marketplace manager functional block of the digital marketplace system shown in FIG. 22.

FIG. 24 is a high-level illustration of the configuration of a GUI used to receive user inputs for searching a catalog of system prompts at the digital marketplace system.

FIG. 25 is flowchart illustrating the steps of the process for performing a search of a prompt catalog implemented by the digital prompt marketplace.

FIG. 26 is a block diagram of a system for providing users with Generative AI services, using system prompts distributed by a digital marketplace system.

FIG. 27 is a flowchart of a process implemented by the system of FIG. 26.

### DESCRIPTION OF AN EXAMPLE OF IMPLEMENTATION

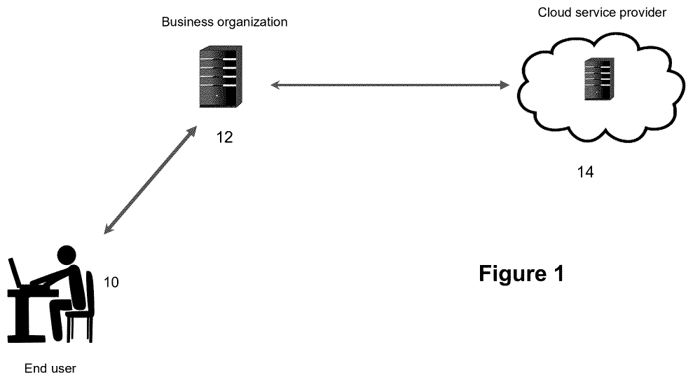

Delivering Language Learning Models (LLMs) services to clients typically involves a robust and well-structured computer infrastructure, exemplified in FIG. 1's block diagram. This infrastructure is implemented as a cloud-based service in this example. Most of the LLM service functionalities are housed within the cloud, and end-users interact with the service through a suitable Application Programming Interface (API).

However, it's important to note that the illustrated architecture is representative and can be altered without departing from the spirit of the invention. For instance, instead of a cloud-based implementation, the LLM could be installed locally. This may be more practical and economical for large-scale users with existing IT capabilities offering sufficient computational capacity to support LLMs.

In FIG. 1, the reference numeral 10 designates the end-user that is interacting with a generative AI, system such as a system based on a GPT architecture. The computer of the end user 10 communicates with a server 12 of a business organization, which in this example is a financial institution. The communication between the computer of the user 10 and the server 12 is performed over a data network such as the Internet. Assume for the purpose of this example that the generative AI system is implemented as a chatbot and the user 10 is asking the chatbot questions in relation to the services provided by the financial institution. In a specific process flow, the chatbot is accessible through the website of the financial organization. As the user accesses the website through a browser, the chatbot window opens and the user can input a question and the chatbot answers the question.

The user question is passed from the servers 12 to the cloud service 14 that services the request. The cloud service 14 is enabled as a series of individual cloud servers 16. These cloud servers 16 not only store the vast amounts of data involved in language learning models, but they also run the complex algorithms used to analyze and learn from that data. They typically use AI Accelerators for efficient functioning of LLMs, such as GPUs (Graphics Processing Units) or TPUs (Tensor Processing Units). They greatly speed up the training and inference times of the models. Also, the cloud servers 16 are provided with data storage systems: Given the vast quantities of data that LLMs require for training and operation, robust and secure data storage systems are used. These systems not only store the raw data and the models but also backups, logs, and other related information. Depending on the nature of the data and the regulatory environment, these may need to be localized or have specific security features.

The cloud servers 16 run the LLM Software Stack which includes the software components such as the machine learning libraries and frameworks for building and training LLMs, such as TensorFlow or PyTorch. Additionally, server software, databases, user interface applications, and APIs for client access are all part of the stack.

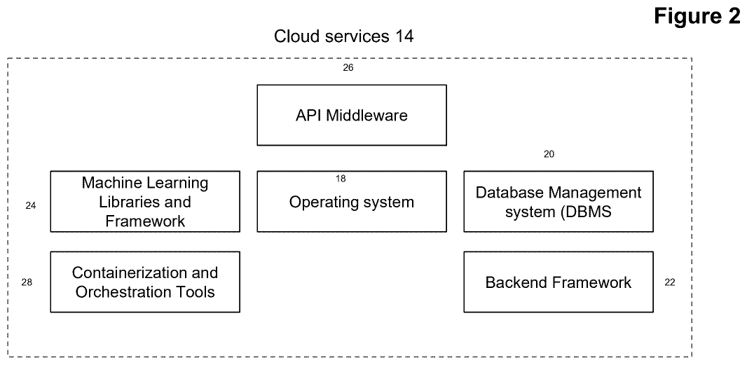

FIG. 2 illustrates in greater detail the software stack of an LLM infrastructure. As mentioned previously, the software stack is executed by the one or more processors, such as CPUs and/or GPUs of the cloud servers 16.

Typically, the service stack includes an operating system functional block 18 for the management of hardware resources and also the management of services for all the other software functional blocks. Possible choices include Linux distributions due to their stability and flexibility.

The Database Management System (DBMS) 20 interoperates with the operating system functional block 16. The DBMS 20 is responsible for managing the vast amount of data associated with LLMs, including training data, user data, and model data. Possible choices include relational databases like PostgreSQL or MySQL, and NoSQL databases like MongoDB or Cassandra, depending on the specific data needs.

The Backend Frameworks functional block 22 refers to an array of server-side frameworks that can be used to build software capable of handling the complexities associated with managing large language models. GPT-3 or GPT-4 by OpenAI are examples of large language models. Given the significant computing power and memory requirements of these models, it is useful that these frameworks offer robust performance, efficient resource management, and scalability. The key tasks they manage include handling API requests, and managing database interactions, among others. Examples of such frameworks include Node.js, Django, and Ruby on Rails.

Machine learning libraries and frameworks 24 provide pre-written code to handle typical machine learning tasks, from basic statistical analysis to complex deep learning algorithms. They help speed up the development process, make machine learning more accessible, and foster reproducible research. Here are examples of machine learning libraries and frameworks:
1. TensorFlow: An open-source library developed by the Google Brain team, TensorFlow is a popular tool for creating deep learning models. It provides a comprehensive ecosystem of tools, libraries, and community resources that facilitate the development and deployment of ML-powered applications. TensorFlow also supports distributed computing, allowing models to be trained on multi-machine setups.
2. Keras: A high-level neural networks API, capable of running on top of TensorFlow, CNTK, or Theano. It was designed to enable fast experimentation with deep neural networks. It focuses on being user-friendly, modular, and extensible.
3. PyTorch: Developed by Facebook's AI Research lab, PyTorch is a popular choice for creating dynamic neural networks in Python. PyTorch emphasizes flexibility and allows developers to work in an interactive coding environment, as opposed to the static computation graph approach of TensorFlow.
4. Scikit-learn: A Python-based library that provides simple and efficient tools for data mining and data analysis. It's built on NumPy, SciPy, and matplotlib. It provides various algorithms for classification, regression, clustering, dimensionality reduction, model selection, and preprocessing.
5. XGBoost/LightGBM/CatBoost: These are gradient boosting libraries that provide a highly efficient, flexible, and portable implementation of gradient boosting algorithms. They're commonly used for supervised learning tasks, where they have shown to be highly effective.
6. OpenCV: Open-Source Computer Vision Library (OpenCV) is a library of programming functions mainly aimed at real-time computer vision. It's used for tasks like object identification, face recognition, and extracting 3D models of objects.
7. NLTK/Spacy: These libraries are used for natural language processing in Python, which includes tasks like part-of-speech tagging, noun phrase extraction, sentiment analysis, classification, translation, and more.
8. Gensim: A robust open-source vector space modeling and topic modeling toolkit implemented in Python. It uses NumPy, SciPy, and optionally Cython for performance. Gensim is specifically designed to handle large text collections, using data streaming and incremental online algorithms, which differentiates it from most other scientific software packages that only target batch and in-memory processing.

The API Middleware functional block 26 is a software component responsible for processing client requests and responses between the web server and the application.

Containerization and Orchestration Tools 28 are used to package the application and its dependencies into a container for easier deployment and scaling. Docker is an example of a commercially available software for containerization, and Kubernetes is an example of a commercially available product used for orchestration, managing the deployment, and scaling of containers across multiple machines.

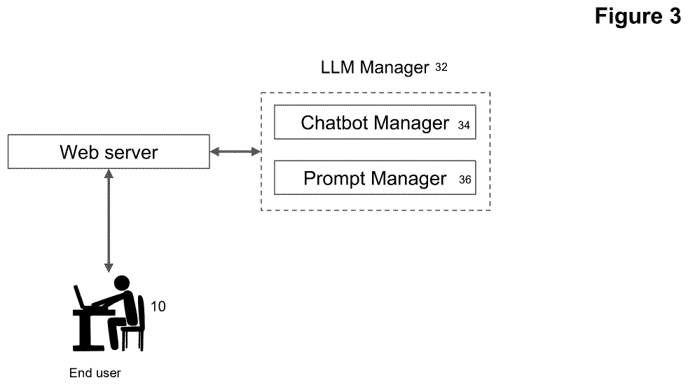

In the context of FIG. 3, which outlines the software structure of servers 12 within a financial institution, the web server 30 provides digital access to the institution's services and products. The web server 30 is integral to the institution's online presence, hosting the institution's website and other web-based applications. It acts as the intermediary between the end-user and the institution's digital offerings.

When end-users connect to the institution's website via their browser, they're communicating with the web server 30, which returns the requested webpage or service.

Under normal operation, the web server 30 receives HTTP or HTTPS requests from clients, which typically include end-users on their personal computers or mobile devices. These requests can range from a simple webpage load, where the user wants to view information, to more complex transactions like transferring funds between accounts, making payments, or performing trades in the case of an investment firm.

The web server 30 would also interact with a variety of other software components to provide its services. For instance, it may communicate with an LLM manager 32 to provide AI-driven services like a chatbot. It might also interact with security systems to protect user data and ensure regulatory compliance.

This LLM manager 32 includes a sub-component known as a chatbot manager 34, which is responsible for managing the operation of the chatbot. This can include tasks like authentication, interpreting user input, managing the flow of conversation, ensuring responses are generated correctly by the LLM, maintaining conversation context, and handling errors or exceptional situations in the interaction.

For instance, when a user inputs a query, the chatbot manager 34 interprets the query and determines the best way to use the LLM to generate a response. This may include feeding the user's query to the LLM, receiving the generated response from the LLM, and ensuring the response is delivered back to the user in an appropriate format.

The architecture is designed in a modular manner, allowing the introduction of managers for other types of services powered by the LLM. If the financial institution decides to introduce additional LLM-based services (e.g., automated report generation, sentiment analysis of customer feedback, etc.), corresponding managers for those services could be integrated into the LLM manager 32.

In this configuration, the LLM manager 32 incorporates a prompt manager 34. One functionality of the prompt manager 34 is ‘prompt embedding’. In the context of LLMs, prompt embedding typically involves generating a system prompt, which is distinct from the end-user prompt for the purpose of adding specific instructions or information to the end-user prompt before it's processed by the LLM. The combination of the system prompt and the end-user prompt forms the input prompt which is submitted to the LLM for processing. Examples of instructions or information that can be included in the system prompt include task setting, conditioning, context setting and bias mitigation, among others. This approach helps steer the LLM's response towards a more desired or appropriate answer, making the interaction more efficient and user-friendly.

For instance, if the end-user asks the chatbot a broad question about interest rates, the prompt manager 34 might embed additional context into the prompt such as “Explain like I'm five”, to guide the LLM into generating a simplified, layman's terms explanation of interest rates. This extra information, which is appended to the end-user initial query, guides the LLM's response but is invisible to the user.

Prompt embedding also can be used to maintain continuity in a conversation. For example, if a user asks multiple related questions, the prompt manager 34 could embed earlier parts of the conversation into the prompt for the LLM, helping it generate answers that are consistent and in-context.

In some cases, the prompt manager 34 might embed information or instructions that help ensure the LLM's output aligns with the financial institution's policies, legal regulations or more generally the institution brand. This could include disclaimers, privacy reminders, or steering the LLM away from giving specific financial advice, which could have regulatory implications, tone of the language, etc.

The precise structure and additional functionalities of the prompt manager 34 will be described in more detail subsequently.

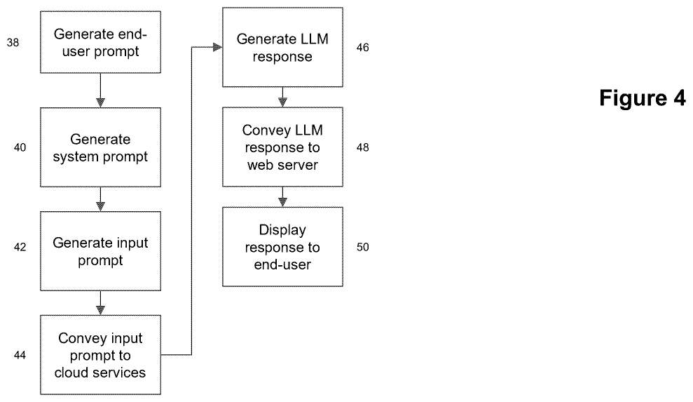

FIG. 4 is a high-level flowchart illustration the series of steps of acts performed when the end-user makes a request for LLM services, such as when the end-user asks a question to the chatbot of the financial institution.

At act 38, the end-user prompt is generated. Typically, this occurs when the end-user types a query in the chatbot window of the financial institution website. At act 40, the prompt manager 36 generates the system prompt. At acts 42 and 44, the chatbot manager 34 generates the input prompt, which in a specific example includes appending the end-user prompt to the system prompt. At act 46, a response is to the system prompt is generated. That response is conveyed to the end-user at acts 48 and 50.

To facilitate the description and understanding of the example of implementation of the invention, the description is separated into the following sections:
A. Mechanisms for Characterizing a Generative AI System: This section outlines the mechanisms used to characterize the generative AI system. It explains the techniques employed to evaluate and assess various aspects of the system's performance. It elaborates on the metrics and evaluation criteria used to generate an informative score.
B. Mechanisms for Reporting the Results of a Characterization Process: This section focuses on the mechanisms involved in reporting the results derived from the characterization of the generative AI system.
C. Mechanisms for Adjusting the Behavior of the Generative AI System: In this section, the mechanisms for adjusting and fine-tuning the behavior of the generative AI system are discussed. It highlights the methods used to modify the system's responses based on the results of the characterization and desired outcomes.
D. Platform for the trade and management for digital products which include prompts for an LLM. These prompts, as discussed earlier can be questions, statements, or any form of input, such as textual input that guide the LLM to produce a desired output. The digital products might be sets or packages of prompts curated for specific purposes, such as academic research, content generation in specific industry areas, programming tasks, or any other function that an LLM can assist with. In a specific example, the platform includes a marketplace where prompt collections are sold to businesses or individuals. For example, a company might purchase a set of prompts tailored for financial analysis or market research. The platform also includes update capabilities, such that the digital products can be updated with new or refined prompts as the LLMs evolve or as new use-cases emerge.

### Mechanism for Characterizing a Generative AI System

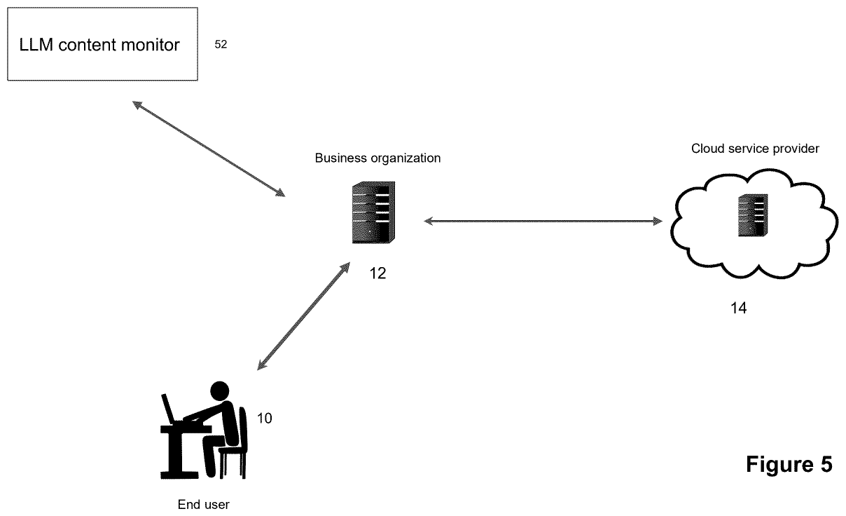

FIG. 5 depicts a block diagram of a Large Language Model (LLM) system infrastructure that includes a content monitoring system, in line with an example of the present invention's implementation. Elements of the LLM system infrastructure that mirror those from FIG. 1 are denoted with the same reference numbers.

The system encompasses an LLM content monitor 52, which is tasked with processing and evaluating the output generated by the LLM system. In a specific example, this evaluation is designed to perform a characterization of the output based on one or more facets. These facets can represent various attributes of the output like accuracy, relevance, policy compliance, regulatory compliance, etc., as described in the previous discussion.

Optionally, the characterization process generates a score that refers to an evaluation number or label. For example, a score can quantify how well the output aligns with benchmarks of facets. This scoring process can include a single aggregated score, and multiple-facet specific scores. The single aggregated score represents the overall performance of the output across all facets. It's an aggregate score that encapsulates the entire evaluation in one number. This type of scoring is beneficial for a quick and simple overall assessment but may lack detail on specific areas of performance. In the multiple-facet specific score, each facet of the output is scored independently, resulting in a multi-dimensional evaluation of the output. This approach offers a detailed breakdown of how well the output performed on each individual facet, which can be useful to diagnose and improve specific areas of the system's performance.

Alternatively, or optionally, the score can convey a qualitative evaluation of the output, such as whether the output is “compliant” with a certain metric or standard or “non-compliant”.

The ‘facets’ could refer to various dimensions or aspects of the LLM's responses. In a specific example, the facets are organized according to one or more main classes, where each class can have one or more categories.

A first class of facets, identified in this document as “quality/usability class” relates to the overall performance and utility of the generative AI system. Some basic examples of facets might include:
1. Accuracy: The information provided in the response is factually correct.
2. Clarity: The response is clear, easy to understand, and free from ambiguity.
3. Relevance: The response addresses the user's query directly and appropriately.
4. Policy Compliance: The response aligns with the institution's policies and guidelines.
5. Regulatory Compliance: The response adheres to relevant legal and regulatory standards, particularly important in sectors such as finance.
6. Ethics and Fairness: The response respects ethical guidelines and does not show bias or discrimination, such as racial bias, gender bias or other undesirable bias.
7. Security/Adversarial Attacks and Privacy: The response does not violate the user's privacy or the institution's security protocols.

A second class of facets is related to “image” or branding. When designing and implementing chatbots or any form of AI-powered customer interaction systems, it's beneficial to consider the brand image and unique brand personality. These not only dictate the kind of information the chatbot provides but also the tone, language style, and interaction approach it should use. This tailoring ensures that the chatbot's communication aligns with the brand's identity, contributing to a cohesive customer experience.

For instance, a chatbot designed for a movie theater might use more casual, colloquial language, and could even include references to popular movies or actors to keep the conversation light, fun, and engaging. It could have features like movie recommendations based on user preferences, booking tickets, providing showtimes, and offering special promotions.

On the other hand, a chatbot for a financial institution would likely adopt a more formal and professional tone, reflecting the serious nature of financial transactions and information. Its features could include answering queries about interest rates or fees. It may also need to handle more complex security and privacy concerns due to the sensitive nature of financial data.

These subtle distinctions help shape the user's perception of the brand and can greatly enhance the user experience. By aligning the chatbot's behavior with the brand image, businesses can reinforce their brand values, build trust, and foster stronger connections with their customers.

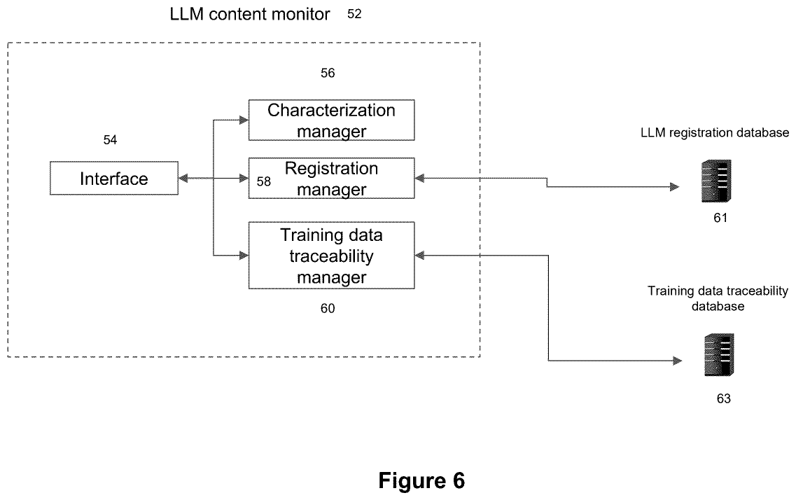

FIG. 6 illustrates the architecture of what is herein termed as the “LLM content monitor,” a system designed to supervise the content produced by the Language Learning Model (LLM). In one implementation scenario, the LLM content monitor, denoted as 52, can be operated by a third-party entity that is distinct from the business organization 12 and the cloud service provider 14. The LLM content monitor 52 comprises an interface, represented as 54, which accepts a request to characterize a generative AI system or undertake other related tasks, and provides the results of the characterization once the process is concluded. In a particular instance, an IT administrator from the business organization 12 might initiate the LLM characterization services by the LLM content monitor 54 by utilizing an appropriate API call, which concurrently transmits pertinent data and parameters. The LLM content monitor 52 includes a characterization manager 56, which performs the characterization of the LLM behavior, as it will be described in detail below. In a specific example of implementation, the characterization manager submits test data to the LLM and analyzes the output generated by the LLM on the basis of the test data. The assessment of the output of the LLM may include computing a score according to a certain metric.

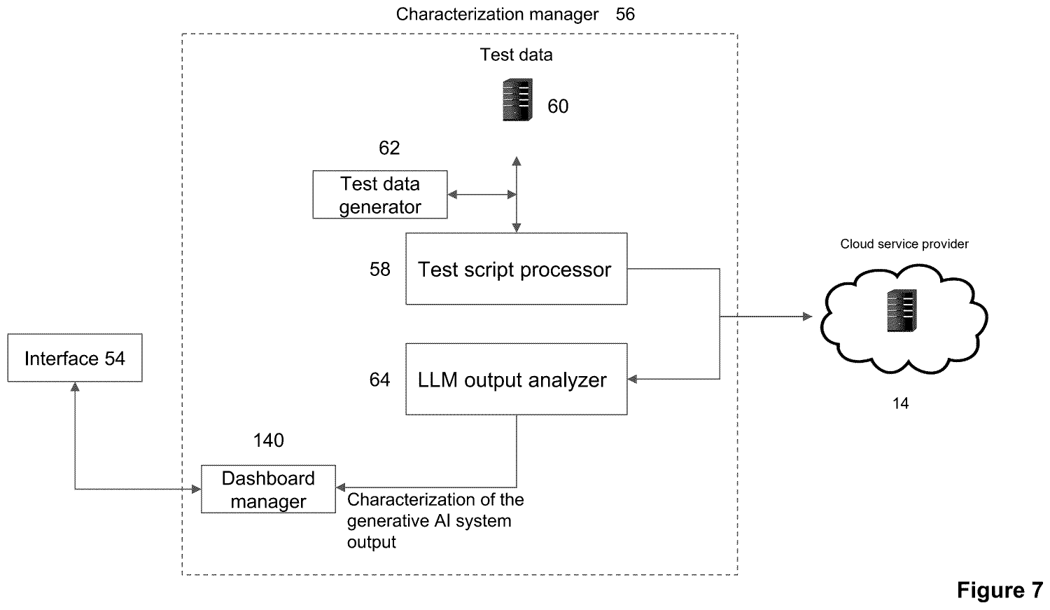

FIG. 7 is a more detailed block diagram of the characterization manager 56. The characterization manager 56 includes a test script processor 58, which is a functional block that executes a series of testing steps, referred to as “test script” to characterize the behavior of the LLM. The test script processor 58, generates a set of instructions or commands written in a programming language, designed to be executed to test a specific functionality or facet of the LLM output.

The test script processor 58 interacts with a test data database 60, which contains the test data that is fed into the LLM powering the generative AI system. Within the test data database 60, this data is systematically partitioned per the delineated test protocols intended for execution. To elaborate, the test data is segmented into discrete data blocks, each uniquely mapped to a specific test protocol for the generative AI framework. Consequently, upon the test script processor 58 ascertaining a predefined test set for execution, it programmatically extracts the requisite data from the pertinent data blocks within the test data database 60, corresponding to the chosen test protocols.

The test data, used for evaluating a particular facet of the generative AI system's operation and stored within a specific block of the database 60, could either be static or dynamically generated. For static data, the information remains consistent across multiple test runs. On the other hand, dynamically generated data varies over time. This dynamically generated test data is produced following rules specifically tailored to the facet under examination. As shown in FIG. 7, a test data generator 62 which communicates with the database 60 and with the test script processor 58 is the software entity for dynamically generating test data. Examples of test data will be provided later when the specific tests will be discussed.

The characterization manager 56 further includes an LLM output analyzer 64 which processes the output of the LLM generated in response to the test data to produce a characterization of the generative AI system.

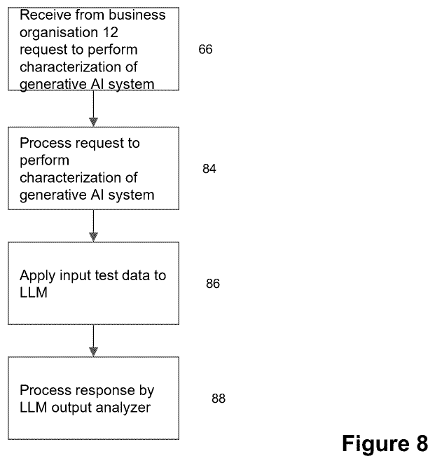

FIG. 8 is a flowchart which depicts the various acts performed by the characterization manager 56 when a generative AI system is being tested.

At act 66, the characterization manager 56 obtains from the business organization 12 a request to conduct characterization of a generative AI system. As previously mentioned, this characterization request can be transmitted via an API call through the interface 54. In a particular instance, the characterization request includes an API key that facilitates the characterization manager's interaction with the appropriate LLM located at the cloud service provider 14. Considering that multiple different LLM models would typically be hosted by the cloud service provider 14, the API key and model deployment identifier delivered to the characterization manager 56 enables access to the correct LLM that needs to be tested.

In a potential variant, the characterization request outlines the characterization process to be executed. For instance, the request might indicate the specific tests that need to be carried out as part of the characterization process. Under such variant, the LLM manager 32 implements logic allowing the IT administrator to specify the tests to be performed as part of the characterization, in addition to triggering the characterization process by the API call. Specifically, the LLM manager 32 implements a user interface, such as a GUI, or Graphical User Interface, which is a type of user interface that allows users to interact with a computer through graphical controls. In a GUI, a user can use a mouse, keyboard, touch screen, or other input device to manipulate visual control elements on a screen. These elements often include windows, icons, buttons, menus, and sliders. The GUI includes visual elements or controls allowing the IT administrator to select the tests to be performed and deselect (or not select) test that are not required. The GUI can be organized by presenting a list of tests with corresponding checkboxes. The IT administrator makes the appropriate selections and triggers the characterization process. Therefore, the request for characterization that is received by the characterization manager 56 includes the selection of tests made by the IT administrator.

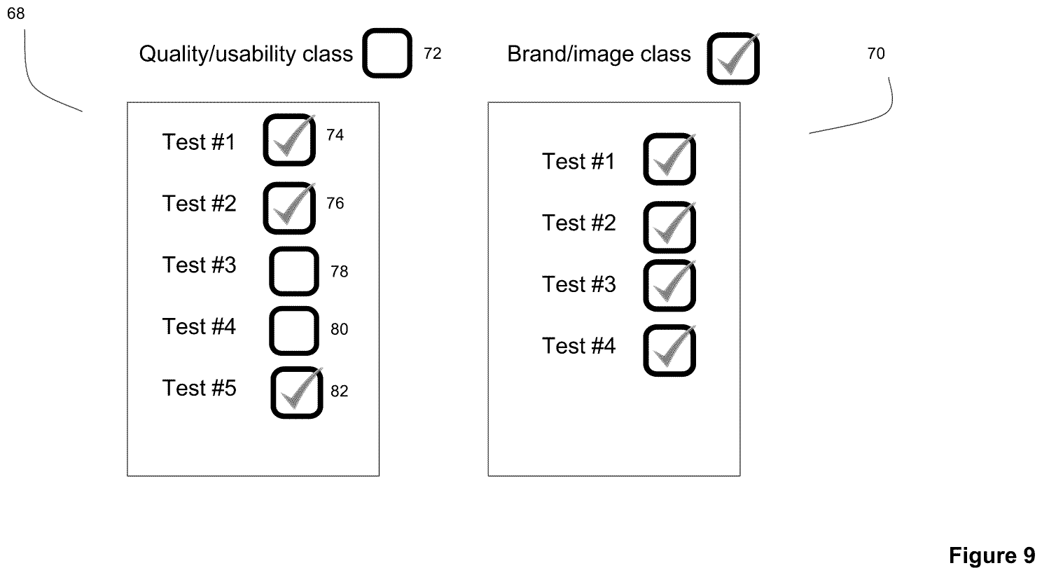

Illustrated in FIG. 9 is a graphical user interface (GUI) enabling the IT administrator to select various tests to be executed. The GUI includes multiple visual elements functioning as controls, facilitating input selection by the IT administrator. To enhance practicality, the tests are grouped into themes or classes. Specifically, there are two classes depicted: the quality/usability class 68 and the image/brand class 70. However, it is worth noting that additional classes can be included or omitted based on the requirements.

Within the GUI, a primary selection control 72 is associated with the quality/usability class 68, allowing the IT administrator the ability to globally select all the tests within that class. In the given example, the quality/usability class 68 comprises five tests. Activating the control 72 would automatically select all the individual test controls (74-82) linked to the quality/usability class 68. Deactivation or de-selection of the control 72 would operate to de-activate or de-select all the individual test controls (74-82), thus allowing the IT administrator to make individual test selections. In the example shown in FIG. 9, the control 72 is deselected, and individual tests #1, 2 and 5 are enabled by selection of their respective controls 74, 76 and 82, while tests #3 and 4 are not selected. Accordingly, only tests #1, 2 and 5 will be performed.

Similarly, the brand/image class 70 follows a similar test selection approach, allowing the IT administrator to manage its tests.

It is worth mentioning that in the aforementioned example, checkboxes are used as controls. However, the GUI is not limited to checkboxes alone. Various other types of controls can be utilized to enable individual or global selection of tests.

Referring back to FIG. 8, in particular act 66, the characterization manager 56 receives from the IT administrator the request to perform the characterization process in which is embedded the selection of the specific tests performed via the GUI. As indicated earlier, the request for characterization also conveys the credentials allowing the characterization manager 56 to access the correct LLM residing at the cloud service provider 14, such as the API key and any other credentials necessary to achieve access.

At act 84, the request to perform characterization is processed by the test script processor 58. This involves, for each specific test to be performed, to gather a test dataset, which includes input test data that will be submitted to the LLM. If the input test data is static, the input data would be fetched from the test data database 60. In this case, the test script processor 58 identifies the relevant data block in the database 60 which is associated with the specific test and reads the data stored in that block.

In a particular scenario, the test data includes input prompts that stimulate the tested LLM to produce an output. When the input test data comprises static information, the input prompt remains the same across different test runs. However, solely relying on static input prompts may not always be ideal from a comprehensive testing standpoint, as it is likely to elicit similar or identical outputs each time.

To capture a broader perspective of the LLM's responses and enhance test coverage, the use of dynamically generated input test data can be advantageous. By generating input test data dynamically, the prompts can vary across test runs, introducing new and diverse inputs to elicit varied responses from the LLMs. This approach aids in characterizing the LLM's behavior in a broader context, facilitating a more comprehensive evaluation of its capabilities and performance.

The dynamically generated input test data is produced by the test data generator 62. The dynamically generated input test data can be produced by using as a starting point static input test data which is fetched from the database and then generating versions of the static input test data, which are semantically similar to the static input test data but expressed using different words. For instance, this can be achieved by feeding the static input test data to a reference generative AI system to produce “semantically similar but lexically distinguishable” input test data, which refers to a situation where two or more phrases, sentences, or expressions share a similar meaning or convey similar ideas, but they are composed of different words or have distinct lexical forms. Despite the differences in word choice or specific wording, the underlying semantic content or intended message remains similar or closely related.

In other words, the phrases or expressions may have different lexical representations, possibly using alternative vocabulary, synonyms, or rearranged sentence structures, while still conveying a comparable or equivalent meaning. This distinction emphasizes the presence of semantic similarity despite the observable lexical differences.

In specific test cases, the test dataset contains reference response data along with the input prompts. These reference responses represent the desired output that the LLM model should generate in response to each input prompt. The presence of reference response data allows for the evaluation of the LLM's response to the input prompts using specific evaluation metrics associated with that particular test.

By including reference response data, it becomes possible to measure the LLM's performance. The evaluation metrics associated with the test can be applied to compare the LLM's generated responses to the reference responses. This comparison enables the determination of how well the LLM aligns with the desired output.

At act 86, the input test data is applied to the LLM. After the test script processor 58 obtains access to the LLM to be characterized at the cloud service provider 14, the input test data is applied.

At act 88, the response generated by the LLM is processed by the LLM output analyzer 64 according to the specific test protocol. Examples of the processing are discussed below.

In the context of the quality/usability class of tests, the following tests can be used individually or collectively to characterize the LLM output according to this class:
1. Accuracy: The information provided in the response is factually correct.
2. Clarity: The response is clear, easy to understand, and free from ambiguity.
3. Relevance: The response addresses the user's query directly and appropriately.
4. Ethics and Fairness: The response respects ethical guidelines and does not show bias or discrimination, such as racial bias, gender bias or other undesirable bias.
5. Regulatory Compliance: The response adheres to relevant legal and regulatory standards, particularly important in sectors such as finance.
6. Security/Adversarial Attacks and Privacy: The response does not violate the user's privacy or the institution's security protocols.

Note, this list of tests is not exhaustive and other tests can be included in this class or omitted.

### Accuracy

Evaluating the accuracy of an LLM poses inherent challenges due to the potential presence of hallucination, where the model generates text that appears plausible but is factually incorrect. Thus, when assessing the LLM's outputs, one valuable indicator of accuracy is its propensity for hallucination.

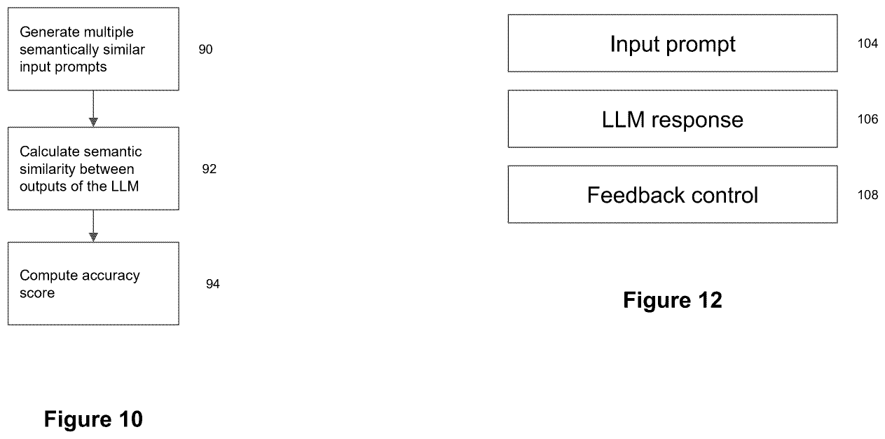

Hallucination refers to the generation of text that may sound convincing and contextually appropriate but is factually incorrect or lacks grounding in reality. The presence of hallucination undermines the accuracy of the LLM's responses. By analyzing the occurrence and severity of hallucination in the model's output, one can assess the fidelity of the generated text to the intended meaning or truthfulness. Several tests can be performed to characterize the accuracy of the LLM, either individually or in combination.
a. Semantic coherence test. This technique evaluates the semantic coherence of the LLM's output to identify instances of hallucination. The underlying principle is that hallucination is a random and incoherent process. Consequently, when the LLM is presented with a series of semantically similar prompts, the generated outputs should also exhibit semantic similarity to each other if they are accurate and free from hallucination. However, if there is some degree of hallucination present, the level of semantic similarity between the outputs could degrade. This degradation could be used as an indicator of the extent of hallucination occurring within the LLM's responses. By analyzing the degree of semantic similarity among the outputs, this technique provides insight into the presence and severity of hallucination. The flowchart at FIG. 10 illustrates in more detail the process.

At step 90, a set of semantically similar input prompts is generated. These prompts may encompass various ways of asking the same question but with different phrasing or wording. At step 92, these input prompts are individually provided to the evaluated LLM model for processing. The resulting outputs from the LLM for each input prompt are collected and compared to evaluate their semantic similarity.

One approach to assess semantic similarity is by computing sentence embeddings for each output. Sentence embeddings capture the semantic meaning of a sentence in a numerical representation. By generating embeddings for the LLM's output sentences, it becomes possible to compare the embeddings and establish the degree of semantic similarity between the outputs.

Through techniques such as cosine similarity or other similarity measures, the computed embeddings of the LLM's output sentences can be compared pairwise. Higher similarity scores indicate greater semantic similarity between the corresponding outputs, while lower scores suggest differences in the meaning or semantics.

By leveraging sentence embeddings and similarity measures, this technique enables the assessment of semantic coherence and the detection of potential discrepancies or variations in the LLM's responses to the semantically similar input prompts.

If the similarity scores between pairs of responses consistently demonstrate alignment, the scores indicate a lower likelihood of hallucination. In this case, the responses exhibit semantic similarity and are coherent with each other, suggesting a more accurate and reliable output from the LLM.

On the other hand, if one or more responses show low similarity scores with the rest of the responses, it suggests the presence of some degree of hallucination. The lack of semantic alignment indicates inconsistencies or deviations in the LLM's generated outputs, which could be attributed to inaccuracies or the influence of unrelated information.

At act 94, the accuracy score is computed on the basis of the similarity scores determined at act 92. The accuracy score can be a number ranging from 0-1, where 1 is indicative of high accuracy and 0 indicative of low accuracy or elevated presence of hallucination. For instance, the accuracy score could be the lowest similarity score achieved between respective pairs of the answers, normalized to fall in the range 0-1.

It should be noted that the accuracy of an LLM can vary depending on the context of the input prompts. Different topics or domains of knowledge may present varying degrees of accuracy in the LLM's responses. For example, finance-related prompts may yield higher accuracy scores compared to technology-related prompts, reflecting the model's proficiency in different subject areas.

To account for this variability, testing for accuracy can involve generating multiple sets of input prompts that are specifically tailored to different topics, contexts, or areas of interest or more generally domains of knowledge. Each set would focus on a particular domain of knowledge. By testing the LLM's performance across diverse sets of prompts, it is possible to obtain a more comprehensive assessment of its accuracy across various contexts.

By evaluating the accuracy within specific domains of knowledge, it is possible to gain insights into the LLM's strengths and weaknesses. This approach allows for a more nuanced understanding of the model's performance and enables targeted improvements based on specific domains of knowledge.

In summary, addressing the variability of LLM accuracy involves designing testing methodologies that encompass multiple sets of input prompts, each relevant to a particular domain of knowledge. This approach enables a more thorough evaluation of the model's accuracy across various domains and assists in identifying targeted areas for improvement or specialization. In this example, the test data utilized for evaluating the LLM's accuracy includes multiple sets of input prompts associated with different domains of knowledge. These sets of input prompts can be sourced from the test data database 60 or generated by the test data generator 62.

To express the accuracy of the LLM in a more detailed and granular manner, the accuracy score incorporates a set of domain-specific scores. Instead of relying on a single score value, this approach provides individual accuracy scores for each domain of knowledge being tested. Each domain-specific score represents the LLM's performance and accuracy within that particular domain of knowledge.

By including domain-specific scores, it becomes possible to analyze the LLM's accuracy in a more nuanced way. This allows for the identification of variations in performance across different domains, highlighting strengths and weaknesses specific to each domain. It provides higher granularity in assessing the LLM's accuracy and enables targeted improvements or optimizations for specific subject areas.

As a simple example, the reporting on the accuracy facet of the LLM can be presented to the user, such as the IT administrator, as follows:

Accuracy score matrix

| Domain of knowledge | Accuracy score (0-1) |
|---|---|
| Domain A | 0.5 |
| Domain B | 0.8 |
| Domain C | 0.3 |
| Domain D | 0.7 |

b. Reference knowledge base. The reference knowledge base approach involves comparing the outputs of the LLM to a separate database of information that is considered accurate and serves as a “ground truth.” This technique provides a more robust evaluation of accuracy compared to the semantic coherence test mentioned earlier. Although it requires an additional knowledge base, it yields conclusive results by comparing the LLM's output to known correct information.
Advantageously, the knowledge base should contain structured data relevant to the domains in which the LLM's accuracy is being tested. The testing process entails obtaining an input prompt from the test data database 60 and/or the test data generator 62, designed to elicit a response from the LLM within the domain of interest. The LLM's response is then compared to the corresponding information in the knowledge base.
The comparison between the LLM's output and the content of the knowledge base can be conducted by the LLM output analyzer 64 based on semantic similarity, as discussed previously. By leveraging techniques such as semantic similarity measures, the level of correspondence between the LLM's generated output and the information in the knowledge base can be assessed.

### Clarity

Clarity refers to the degree of understanding and readability of the text generated by the LLM. It assesses how well the LLM expresses its ideas, conveys information, and presents the content in a coherent and comprehensible manner. Clear outputs are easily understood by humans, exhibit proper grammar, sentence structure, and are free from ambiguity or confusion. Clarity focuses on the quality of language expression and the ability to effectively communicate the intended message.

On the other hand, accuracy, discussed earlier pertains to the correctness and factual validity of the LLM's generated outputs. It measures the extent to which the generated text aligns with the truth or factual information. Accurate outputs are reliable, precise, and factually correct. Accuracy focuses on the ability of the LLM to provide correct answers, information, or responses to specific queries or prompts. Several tests can be performed to characterize the clarity of the LLM, either individually or in combination.
a. Readability test. Flesch-Kincaid is an example of an evaluation to assess readability of the generated text, which is an indicator of clarity. The Flesch-Kincaid readability test provides a numerical score that indicates the ease of reading and comprehension required to understand the text. The test calculates the readability score based on two factors: average sentence length and average syllables per word.
   The formula to calculate the Flesch-Kincaid readability score is as follows:

$$Readability score = 0.39 ⋆ ( average sentence length ) + \text{} 11 . 8 ⋆ ( average syllables per word ) - 15.59 .$$

The resulting score corresponds to a grade level, indicating the level of education required to understand the text. For example, a score of 6.0 would suggest that the text is readable by an average 6th grader, while a score of 12.0 would indicate a readability level suitable for a typical 12th-grade student.
The Flesch-Kincaid readability test considers sentence length and word complexity to estimate the comprehension level required to understand the text. Shorter sentences and words with fewer syllables contribute to a lower readability score, indicating easier readability.
Advantageously, the LLM output analyzer 64 can compute the readability score on a domain-specific basis, similar to the semantic coherence test discussed earlier. As a result, the output analyzer 64 generates separate scores for individual domains of knowledge, providing domain-specific readability assessments. Thus, the output analyzer 64 generates readability scores for each specific domain of knowledge, reflecting the clarity and readability of the LLM's outputs within those domains. This approach allows for a more fine-grained assessment of the LLM's readability performance across different subject areas. This approach helps identify areas where improvements may be needed to enhance the clarity and accessibility of the LLM's responses within different domains.
b. SMOG (Simple Measure of Gobbledygook) readability test is another method for assessing the readability of a text by measuring the complexity of its vocabulary. It provides an estimate of the education level required to comprehend the text effectively. The SMOG test focuses primarily on the number of polysyllabic words in a given passage.
   The LLM output analyzer 64 performs the SMOG readability test, by counting every word with three or more syllables in the response generated by the LLM, calculates the square root of the total number of polysyllabic words and adds 3 to the square root computation to obtain the SMOG index.
   The resulting SMOG index corresponds to a grade level, indicating the level of education required to understand the text. For example, if the SMOG index is 10, it suggests that the text can be understood by an average 10th-grade student.

### Relevance

Relevance refers to how well the generated LLM responses align with the specific information or context requested in the given input prompts or queries. It assesses the degree to which the generated outputs address the intended meaning, provide relevant information, and effectively respond to the input. Relevance testing focuses on the appropriateness and usefulness of the LLM's responses within the given context.

Accuracy is a somewhat different concept from Relevance. Accuracy relates to the correctness and factual validity of the LLM's generated responses. It evaluates how accurately the LLM captures and presents information. Accuracy testing aims to determine if the generated outputs contain factual errors, misinformation, or inconsistencies with known or expected information. Accuracy testing ensures that the LLM's responses are reliable and aligned with the truth.

To put it simply, an LLM response can be factually correct but still miss the mark in terms of relevance to the input prompt. Therefore, Relevance and Accuracy are related yet distinct metrics that measure different aspects of the LLM's performance. By considering both factors, it is possible to gain a more complete understanding of how effectively the LLM meets the requirements and expectations of generating accurate and contextually appropriate responses.

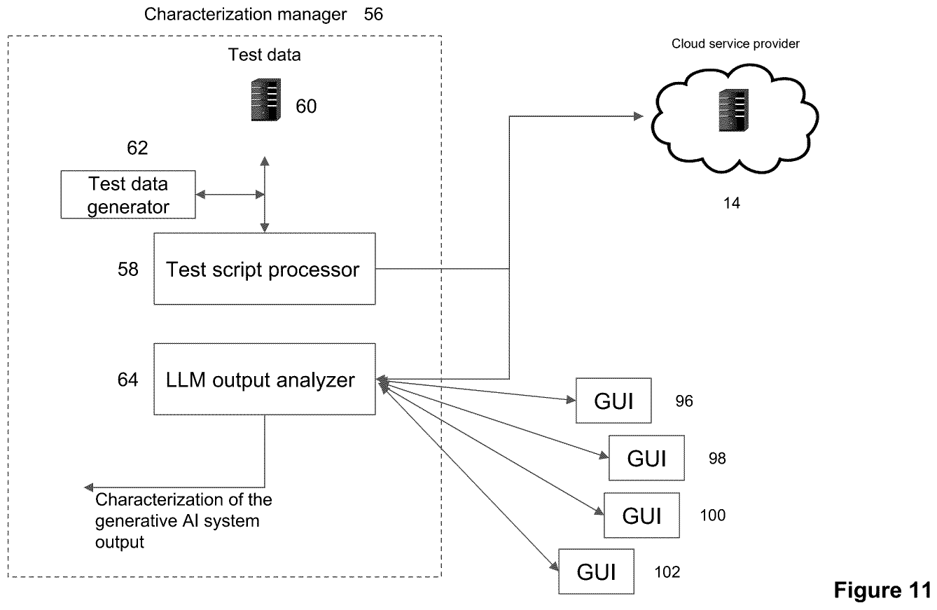

Several tests can be performed to characterize the clarity of the LLM, either individually or in combination. Examples of those tests are described below:
a. Human evaluation. This technique employs human judges or domain experts to assess the relevance of the LLM's responses. They can evaluate the responses based on their subjective judgment and expertise, determining the degree to which the generated outputs address the given prompts or queries. In this example, the LLM manager 32 is enhanced with the functionality to manage a User Interface (UI), such as a Graphical User Interface (GUI). This UI enables the presentation of the input prompt submitted to the LLM and the corresponding generated response to a human evaluator. The evaluator can then provide feedback on the relevance of the response.
   In practice, the LLM manager 32 generates multiple instances of the GUI to accommodate multiple human evaluators. Each evaluator can interact with their respective GUI instance to perform the evaluation, resulting in a broader and more diverse sample of responses. This approach allows a variety of perspectives and assessments to be considered when evaluating the relevance of the LLM's generated responses. By involving multiple evaluators, the evaluation process becomes more comprehensive and representative, allowing for a richer understanding of the LLM's performance and facilitating a more robust assessment of response relevance.
   An example of implementation is depicted by the flowchart of FIG. 11. The LLM output analyzer 64 manages several instances of a GUI 96, 98, 100, 102 which are implemented at the computer devices at respective human evaluators locations, where each human evaluator can review on the GUI the response generated by the LLM, gauge the relevance of the response, and provide an input that characterizes this relevance.
   The number of human evaluators involved in the process can vary, ranging from just one person to several dozen or even more. FIG. 12 provides a conceptual illustration of the GUI instance structure, demonstrating the arrangement of visual elements and controls for conveying information to the human evaluator and receiving input from them.
   Within the GUI, there is a field labeled as 104, which displays the input prompt submitted to the LLM. When an input prompt is retrieved from the test data database 60 or generated by the test data generator 62, it is conveyed to each GUI instance (96-102) or to a subset of them. The input prompt is then displayed in the designated input prompt field 104, allowing the human evaluator to read and comprehend it.
   Likewise, the response generated by the LLM and received by the LLM output analyzer 64 is conveyed to the respective GUI instances (96-102) or a subset of them. The response is displayed in the LLM response field 106 within the GUI, enabling the human evaluator to review the generated output.
   To provide feedback on the relevance of the response to the input prompt, the GUI includes a feedback control 108. In its simplest form, the feedback control 108 can comprise an input mechanism such as radio buttons, allowing the evaluator to provide binary feedback indicating whether the LLM response is relevant or not relevant. Alternatively, the feedback control 108 can offer additional response options, enabling the evaluator to grade the response in terms of its relevance.
   Overall, the GUI structure facilitates the display of input prompts, generated LLM responses, and the collection of evaluator feedback on relevance. This setup provides a systematic approach for evaluators to assess the relevance of the LLM's responses based on the input prompt, utilizing appropriate feedback controls within the GUI.
   The feedback from the individual human evaluators is received by the LLM output analyzer 62 and processed to provide a relevance score. For example, the feedback to a specific input prompt and the corresponding response from the respective human evaluators can be averaged to compute a relevance score.
b. End-user feedback. In this example, the feedback mechanism is integrated in real-time during the LLM's operation when it is being used to serve users. If we consider the case of a chatbot, the GUI presented to the user shares conceptual similarities with the one depicted in FIG. 12, although with some modifications. Field 104 is a user input field where the user types its question, serving as the input prompt. Field 106 is provided to display the response generated by the LLM.
   The feedback control 108 remains continuously active, allowing the user to provide ongoing feedback regarding the relevance of the LLM's response. Users have the opportunity to express their assessment of how relevant the LLM's response is to their query.
   In this particular example, the collected user feedback can be accumulated over time, aggregated, and sent to the LLM output analyzer 64 for further processing. The output analyzer can then utilize this feedback to compute a relevance score, enabling a quantitative measure of how well the LLM's responses align with user expectations.
   When incorporating an end-user feedback mechanism, it can be beneficial to gather not only the user feedback but also the input prompts and the corresponding generated responses by the LLM. This approach enables the accumulation in a reference database of question/answer pairs over time, validated as relevant answers to the specific questions through real-time interactions with users.
   By collecting and storing this reference information, a growing repository of validated question/answer pairs is established. This reference database serves as a valuable resource, containing verified and relevant responses to various user queries. It can be utilized to enhance the performance of the system by leveraging the knowledge and insights gained from previous interactions with users.
   By leveraging the validated question/answer pairs, the generative AI system can better understand user queries, generate more appropriate responses, and continuously refine its performance over time. In this example, where question/answer pairs are collected, the LLM output analyzer can interact with the test data database 60 to store the question/answer pairs in order to augment the test data over time. Advantageously a filter mechanism can be provided to selectively extract or manipulate specific question/answer pairs based on certain criteria or conditions. It allows for the extraction or exclusion of data points that meet predefined rules or parameters, enabling more focused analysis or processing of the dataset.
   The set of conditions or rules that act as a criterion for including or excluding data may include factors, such as the feedback received from the end-user, to remove or eliminate question/answer pairs where the end-user identified the answer as being non relevant, thus retaining only the answers that are considered relevant. Another set of factors that can be built into the filter relate to privacy and confidentiality issues. For instance, a filtering criterion can be provided to remove sensitive data such as personal information, date, location, etc. in order to anonymize the question/answer pair. The filter can also group the question/answer pairs into categories to make the retrieval of the reference data and its identification for other applications easier. For instance, the categories can relate to domains of knowledge or specific applications of the generative AI system. The LLM output analyzer 64 can then store the cleaned up and refined reference data from the filter mechanism into the test data database 60. The various sets of the question/answer pairs as categorized can be identified by suitable metadata, allowing searching and retrieval from the test data database 60 to be facilitated.
c. Reference comparison. Compare the LLM's responses to a set of reference responses that are considered relevant and accurate, to evaluate the level of alignment between the LLM's generated outputs and the reference responses, assessing whether the LLM captures the desired information and context. The reference responses can be generated from real time user-data, as discussed above or they can be generated from human domain experts and stored in the test data database 60. The process to score the relevance facet of the LLM using reference comparison includes, in one example, the following. Test data, which includes an input prompt and an associate response which is considered to be a relevant response, is extracted from the test data database 60. The input prompts from the extracted test data are then submitted to the LLM and the corresponding outputs received and processed by the LLM output analyzer 64. The processing includes comparing the output to the reference responses to establish the degree of semantic similarity between the reference response and the output. The degree of semantic similarity is an indicator of the relevance of the LLM output.

In the context of the “image” or branding facet, the writing style of the LLM's response plays an important role in characterizing the output of the LLM with regards to this class. This facet serves as a means to evaluate how well the LLM's writing style aligns with the organization's desired image and branding objectives. The writing style can be understood as a collection of defining attributes that shape the LLM's overall communication approach. Examples of attributes include:
a. Formality: The degree of formality exhibited in the writing style, ranging from highly formal to informal or conversational.
b. Tone: The emotional quality or attitude conveyed through the language, such as authoritative, friendly, professional, persuasive, or empathetic.
c. Vocabulary: The choice and level of vocabulary used, whether it is simple and accessible, technical and specialized, or elaborate and sophisticated.
d. Sentence Structure: The organization and complexity of sentences, including the use of long or short sentences, varied sentence structures, and sentence patterns.

It should be noted that more or less attributes can be used to characterize the writing style of an LLM response, without departing from the spirit of the invention.

### Mechanisms for Reporting the Result of a Characterization Process

Upon completing the characterization of the generative AI system, as discussed earlier, the obtained results are communicated to the user, typically the IT administrator or another business stakeholder such as the application owner or the model owner who initiated the characterization request. In a specific implementation example, the computed scores that represent different facets of the generative AI system's operation are reported through a dashboard. The dashboard presents an overview of the distinct scores, enabling the user to delve deeper by accessing underlying data at the desired level of detail. This allows the user to gain a comprehensive understanding of the scoring outcomes and, consequently, a better grasp of the behavior exhibited by the generative AI system.

Optionally, the results can be delineated or shaped by highlighting aspects pertinent to distinct stakeholder groups. For instance, a data scientist's examination of the outcomes would generally focus on aspects different from those prioritized by an organizational risk manager. This tailored presentation ensures the alignment of results with the specialized interests and requirements of each audience segment.

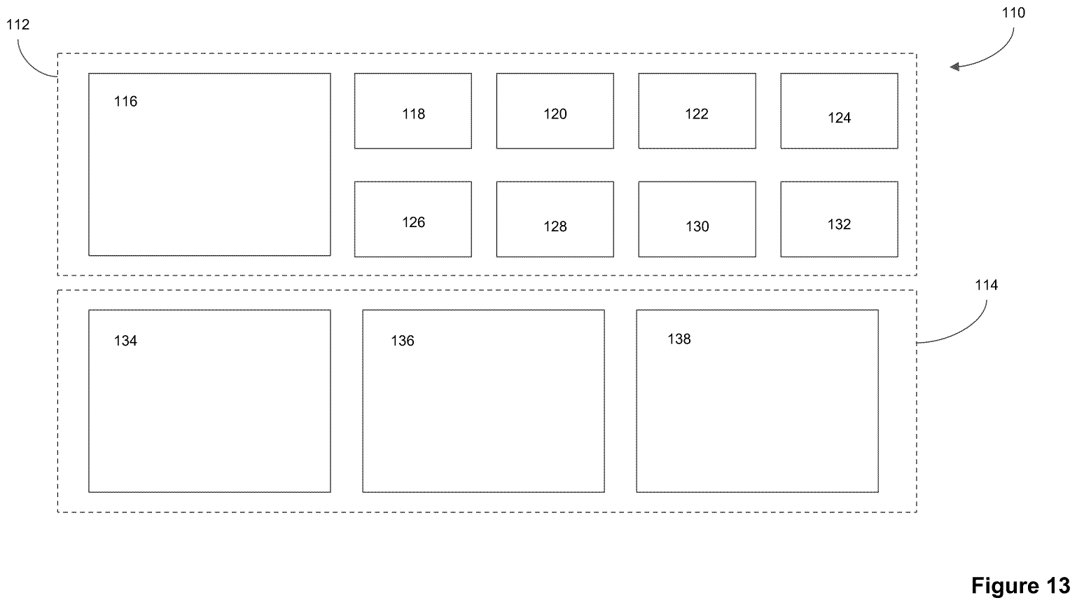

FIG. 13 illustrates an example of a dashboard which can be used to report the scores of the characterization process. The dashboard is configured to present the information according to a hierarchy. The hierarchy of presentation of information refers to the organization and arrangement of information in a structured manner, where each piece of information is assigned a specific level of importance or priority. It involves categorizing and ordering information based on its significance and relevance to effectively convey a message about the behavior of the generative AI system.

In the hierarchical presentation according to this example of implementation, the information is typically organized into different levels. The higher levels usually encompass broader concepts or main ideas, while the lower levels provide supporting details, examples, or specific data.

The purpose of establishing a hierarchy is to guide the user's attention, highlight key points, and facilitate the comprehension and retention of information on the scoring.

As it will be discussed below, there are various methods and visual aids available to represent the hierarchy of information on the dashboard. These include outlines, bullet points, headings, subheadings, numbering, indentation, as well as graphical elements like diagrams, charts, and mind maps. By utilizing these visual cues, the clarity and organization of the presentation are enhanced, allowing the audience to grasp the main message and comprehend the connections between different pieces of information.

Furthermore, these visual aids can also be designed as graphical user interface (GUI) controls. Users can interact with these controls to delve deeper into the information presented. For example, the user can selectively access additional views of the underlying data, enabling a more detailed exploration and understanding of the scoring and behavior of the generative AI system.

The dashboard shown at FIG. 13 is designated generally by the reference numeral 110. The information, such as the different scores are presented as tiers of information. The illustration at FIG. 13 shows 2 separate tiers 112 and 114, but it should be understood that more or less tiers can be shown to the user, depending on user preferences and other factors. For instance, tier 112 is associated with quality/usability class, while tier 114 is associated with the image/branding class.

Tier 112 appears within its designated area or visualization panel of the dashboard, ensuring its distinct presence and visibility. This dedicated space allows tier 112 to be easily differentiated from other tiers. To enhance clarity and understanding, a descriptive title can be provided for tier 112, enabling users to readily identify the information it conveys.

In the hierarchical structure, tier 112 comprises a primary area of information 116 and one or more secondary areas 118-132 of information. The primary area of information 116 within tier 112 can be used as a summary information area, providing a concise overview or a high-level summary of the content contained within the tier 112. It encapsulates the main points or key aspects of tier 112, giving the user a general understanding of the scoring in the quality/usability class. In a specific example, the primary area 116 can convey a global score which is derived from the individual scores associated with the different facets assessed as part of the quality/usability class. For instance, the global score can be an average of all the scores of the different facets under the quality/usability class. In a variant, some facets may be deemed more relevant than others, accordingly the score can be a weighted sum or another form of individual score aggregation or combination to produce a global score. For example, the global score can be a number in the range of 0 to 1, where 0 denotes a low quality/usability while 1 denotes a high quality/usability.

The secondary areas of information 118-132 within tier 112 delve into specific aspects or individual facets related to the tier. Each secondary area provides detailed information and focuses on a particular facet or element of tier 112. These secondary areas expand on the primary area's summary information and provide additional insights into various specific aspects or subcategories within the tier.

By organizing the information in this hierarchical manner, the primary area 116 offers a broad overview to orient the audience, while the secondary areas 118-132 allow for a more granular exploration of specific details or aspects within tier 112. This hierarchical arrangement helps to establish a structured and coherent presentation of information, enabling the audience to navigate through the content effectively and gain a comprehensive understanding of tier 112 and its related components.

In the example of the quality/usability class discussed earlier, the class includes the following facets:
a. Accuracy: The information provided in the response is factually correct.
b. Clarity: The response is clear, easy to understand, and free from ambiguity.
c. Relevance: The response addresses the user's query directly and appropriately.
d. Ethics and Fairness: The response respects ethical guidelines and does not show bias or discrimination, such as racial bias, gender bias or other undesirable bias.
e. Regulatory Compliance: The response adheres to relevant legal and regulatory standards, particularly important in sectors such as finance.
f. Security and Privacy: The response does not violate the user's privacy or the institution's security protocols.

The primary information area 116 displays a combined score reflecting the assessment of the generative AI system per the different facets. Secondary areas (118-128) are associated with respective ones of the facets (a-f) above. Specifically, each secondary area (118-128) displays a visual element that conveys the characterization of the generative AI system according to the respective facet, such as score value.

The visual areas of information (116-132) within the hierarchy are characterized by their dynamic nature, meaning that all or some of them implement an input mechanism having the ability to respond to user input in various ways. This responsiveness allows the visual areas to provide additional information to the user or present the information in alternative formats that may better suit the user's preferences or needs.

When a user interacts with these dynamic visual areas, they can trigger a response that goes beyond the static presentation of information. For instance, upon receiving user input, the visual areas may expand or unfold to reveal more detailed content, providing a deeper level of information related to the specific topic or aspect being explored. This expanded view can include supplementary data or additional explanations.

Furthermore, the dynamic nature of the visual areas allows for customization and flexibility in how the information is presented. Based on user preferences, the visual areas can adapt to display the information in a different format that aligns with the user's preferred style or mode of comprehension. This could involve adjusting the layout, modifying the visual representation, or reorganizing the content to optimize the user's viewing experience and facilitate better information absorption.

For example, in a basic visual presentation layout, the area or pane of tier 112 only shows the primary area of information 116 which provides the summary information. The user has the option to actuate the GUI control underlying the primary area of the information 116 to trigger a response, such as the display of supplementary information. The supplementary information can be the display of the secondary areas (118-132), where each secondary area shows the score associated with each respective facet of the quality/usability class. The score could be a number between 1 and 0. In a possible variant, the secondary areas of information (118-132) are also dynamic GUI components and can respond to user input via a pointing device, touch screen, keyboard input or other input mechanism to cause the dashboard 110 to display yet a tertiary set of information areas (not shown in the drawings) to further expand on the characterization scores. In a specific example, the tertiary information areas break down the scoring for a particular facet according to domains of knowledge, include information on the test context (what data was used, what prompt was used, what LLM version was tested), etc.

As discussed earlier, the term “domain of knowledge” refers to a specific area or field of expertise that focuses on a particular subject matter. It represents a distinct realm of understanding and encompasses a comprehensive set of concepts, principles, theories, practices, and specialized vocabulary associated with that subject.

Domains of knowledge can vary in their breadth and depth, depending on the extent of the subject matter they cover. Some domains, such as mathematics or biology, are broad and encompass a wide range of topics and subfields. They delve into various aspects of their respective disciplines, exploring different branches and applications within the field.

On the other hand, domains of knowledge can also be narrow, focusing on specific and specialized areas of study. For instance, within the field of computer science, there are domains such as artificial intelligence, software engineering, cybersecurity, and data science, each representing a focused area of knowledge within the broader discipline.

In the context of generative AI systems, a domain of knowledge represents an area in which the system has been trained and has acquired knowledge and understanding and accordingly can generate an output when prompted by a user. By combining these domains, the generative AI system forms its operational envelope, allowing it to generate outputs and provide information across a wide range of subjects based on its accumulated knowledge within those domains. The separation of the operational envelope of the generative AI system in respective domains and the granularity of that separation is a matter of choice.

When a user interacts with a secondary area of information, such as area 118 related to the “accuracy” facet, the dashboard responds by generating a subset of tertiary areas of information. Each tertiary area is associated with a specific domain of knowledge.

In this context, the tertiary areas of information within each domain of knowledge would provide relevant insights and data specific to that particular domain of knowledge. For example, within the domain of computer science, the tertiary area might present an accuracy score reflecting the performance of the generative AI system in generating outputs related to computer science concepts. Similarly, within the domain of physics, the tertiary area would display an accuracy score specifically pertaining to physics-related topics.

By generating these tertiary areas of information associated with different domains of knowledge, the dashboard offers a more focused and targeted view of the system's accuracy across various subject areas. Users can gain a better understanding of how well the generative AI system performs within each domain, allowing them to assess the reliability and relevance of the generated content within their specific area of interest.

In the above examples, the performance of the generative AI system is reported by a score in the form of a number. As a possible variant, the score can include categorization labels, where characterization scores can be reported using categorization labels or descriptors that represent different levels or categories. These labels could range from low to high, poor to excellent, or beginner to advanced, providing a clear indication of the assessment level.

The characterization scores can also be reported using visual mechanisms such as bar graphs, pie charts, or color-coded indicators to present the characterization score in a visually intuitive manner. These representations enable users to quickly grasp the relative position or magnitude of the score.

Another option is to provide with the characterization score comparative benchmarks. Reporting the characterization score in relation to benchmark values or comparative references can be useful. This mechanism allows users to understand how the score compares to established standards, average performance, or predefined thresholds.

Finally, mechanisms for reporting characterization scores can also include trend analysis, where the score is presented in the context of historical data or compared over time. This approach provides a longitudinal perspective and highlights any notable changes or patterns in the assessment.

Tier 114 conveys information about the characterization of the class of facets relating to branding/image of the generative AI system. Optionally, as it will be described in detail, tier 114 also provides mechanisms allowing the user to alter parameters of the generative AI system to change the branding/image of the generative AI system, to better align the behavior of the generative AI system with a desired brand/image.

Tier 114 includes a primary area of information 134, which can be a summary area of information where a summary of the characterization for the brand/image class of facets is presented to the user. In the example of implementation discussed earlier, the branding/image class, characterizes the following facets or attributes of the generative AI system, which are reflective of the branding/image:
a. Formality: The degree of formality exhibited in the writing style, ranging from highly formal to informal or conversational.
b. Tone: The emotional quality or attitude conveyed through the language, such as authoritative, friendly, professional, persuasive, or empathetic.
c. Vocabulary: The choice and level of vocabulary used, whether it is simple and accessible, technical and specialized, or elaborate and sophisticated.
d. Sentence Structure: The organization and complexity of sentences, including the use of long or short sentences, varied sentence structures, and sentence patterns.

Note that other attributes can also be used to characterize the branding/image of the generative AI system, without departing from the spirit of the invention.

Tier 112, associated with the quality/usability class of facets, focuses reports on testing performed on the generative AI system to characterize its performance. In contrast, the information reported within Tier 114 may or may not be the outcome of a characterization process.

When a characterization is conducted to quantify or qualify the facets within Tier 114, the results are reported through the dashboard in that tier. These results provide valuable insights into the system's behavior, capabilities, and performance in relation to the specific facets being evaluated.

However, it's important to note that Tier 114 can also encompass other types of data or information that are not directly derived from a characterization process. For example, the data reported within this tier could consist of system settings that users can configure to command a desired behavior from the generative AI system in the context of the branding/image class. These settings allow users to customize the system's response, tone, or output based on their preferences or specific requirements.

In a specific implementation, facets such as formality, tone, vocabulary, and sentence structure are reported as a collection of attributes, diverging from the numerical scoring used for facets in the quality/usability class. Each facet is defined by at least one attribute, preferably multiple attributes, with each attribute being quantified or qualified to provide a comprehensive characterization.

To illustrate, let's consider the formality facet. Within this implementation, the formality facet is defined by a formality attribute. The formality attribute captures an important aspect of the language used. It defines whether the output is more professional, sophisticated, or academic, suitable for formal contexts or business communication, or the output is casual, friendly, or colloquial, suitable for informal conversations or social interactions.

In one example, the primary information area 134 displays a summary of the formality facet setting, which is represented by a slider control between a formal and informal setting. The position of the slider between these two extremes represents the degree of formality or informality in the output generated by the AI system.

Within the primary area (134), users have the ability to modify the slider's position, thereby influencing the tone output of the generative AI system, via the GUI. By adjusting the slider, users can induce a change in the system's tone, shifting it towards either a more formal or informal style.

This interactive control allows users to actively customize the formality facet of the generated output, tailoring it to their specific preferences or requirements. By modifying the slider position, users can effectively influence the level of formality or informality they desire in the language used by the AI system.

Further details on the functionality and effects of the formality output modification will be provided later, outlining how users can manipulate the system's formality facet and other facets to achieve their desired communication style.

The tone facet encompasses various attributes that contribute to the overall style and emotional expression of the output generated by the generative AI system. Some of these attributes include authoritative, friendly, professional, persuasive, empathetic, and others. Together, they define the tone of the generated content, which is essentially related to the emotion conveyed by the output.

In a simplified example, the tone facet can be represented on the dashboard by a (GUI) control that allows users to adjust the degree of emotionality in the output. This GUI control, illustrated in FIG. 13 within the primary display area 136, incorporates a slider control that users can manipulate along a scale ranging from high emotionality attribute to low emotionality attribute.

With this interactive control, users have the ability to modify the tone of the generative AI system by adjusting the slider. Moving the slider towards high emotionality would result in output that conveys a more emotional or expressive tone. On the other hand, sliding it towards low emotionality would yield output with a less emotional or more neutral tone.

The primary display area 138 of the interface incorporates a control mechanism that serves two purposes. Firstly, it allows users to view the current setting of one or more attributes that define a vocabulary facet. Secondly, it enables users to modify that setting, thereby exerting control over the vocabulary facet of the output generated by the AI system.

One attribute that can be utilized to define the vocabulary facet is the level of complexity associated with the words used. For instance, the system may offer a range of vocabulary options, spanning from a simple vocabulary to a more intricate and advanced one.

To facilitate user interaction and customization of the vocabulary facet, the primary display area 138 features a slider control. The slider control can be selectively positioned within the range, enabling users to determine the desired degree of complexity for the vocabulary employed in the generated output.

Through direct interaction with the control, users have the flexibility to re-position the slider at their preferred point along the range. By doing so, they can effectively modify the degree of complexity associated with the vocabulary generated by the AI system.

This approach allows individuals to tailor the output according to their specific requirements, whether they prefer a simpler vocabulary for easier comprehension or a more sophisticated one to convey specialized knowledge or nuance.

The sentence structure facet is also allocated a primary display area, although it is not explicitly depicted in the drawings for the sake of simplicity. This primary display area functions similarly to the one associated with the vocabulary facet 138 and operates as a control interface for users to select their desired sentence structure.

The control within the primary display area enables users to customize the sentence structure of the output generated by the system. One approach to implementing this control is by using a slider that can be adjusted between a simple sentence structure and a complex one.

By moving the slider towards the simple sentence structure end, the generated output will consist of shorter, more straightforward sentences. This style of sentence structure is often easier to comprehend and is suitable for conveying concise information.

Conversely, moving the slider towards the complex sentence structure end would result in the system generating output with longer, more intricate sentences. This allows for the expression of complex ideas, incorporation of subclauses, and greater syntactic complexity in the generated text.

The primary display area for the sentence structure facet provides users with an intuitive and interactive means to adjust the sentence structure of the generated output according to their preferences or specific requirements.

Although not explicitly shown in the drawings, this primary display area operates in conjunction with other facets and controls, such as the vocabulary facet, to enable users to customize various aspects of the generative AI system's output.

In a possible variant, the primary display areas 134, 136 and 138 are designed to be responsive to user input to provide additional information regarding the respective facets, such as provide a more granular view of the setting across a range of domains of knowledge. For example, in relation to the formality facet, a different setting may be preferred in one domain of knowledge than in another. In this example, the dashboard responds to user input to display the formality facet settings associated with respective domains of knowledge.

FIG. 7 illustrates the architecture of the characterization manager 56 which includes a dashboard manager 140 to perform the various functions discussed above. The dashboard manager 140, as with the other functional elements of the characterization manager 56 is software implemented. At an input, the dashboard manager receives the characterization data generated by the LLM output analyzer 64 and generates the necessary signals, which are conveyed via the interface 54 to the end-user computer. Those signals, include software code which causes the CPU of the end-user computer to implement the GUI including the dashboard. Similarly, signals generated as a result of the user interaction with the dashboard, which convey user selections or user commands input at anyone of the controls implemented at the dashboard are conveyed via the interface 54 to the dashboard manager 140.

### Mechanisms for Adjusting the Behavior of a Generative AI System

As highlighted earlier, prompt engineering is a mechanism of providing inputs and instructions for Generative AI systems that will produce the desired outputs. This approach primarily revolves around adjusting the prompts or inputs fed into the system, which in turn shapes its resulting outputs. The current invention introduces methods to automate the composition of these prompts, allowing for adjustments in aspects like branding or image class facets via the dashboard interface.

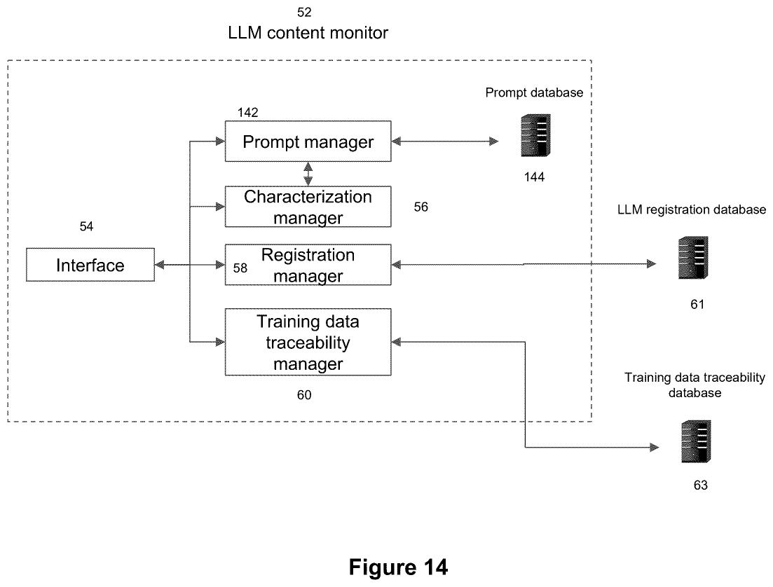

In a detailed example illustrated in FIG. 14—a variation of the setup depicted in FIG. 6—the LLM content monitor, designated as 52, is provided with a prompt manager labeled 142. This prompt manager is linked to a prompt database 144.

The prompt manager 142, like the other functional blocks of the LLM content monitor 52, is realized through software. The prompt manager communicates with the characterization manager 56, which in certain embodiments of the invention encompasses the dashboard manager 140. Furthermore, the prompt manager 142 can establish communication with the user's computer using the interface 54.

To offer a high-level understanding, one role of the prompt manager 142 is to obtain user inputs from the dashboard. This pertains to the choices users make on the dashboard, specifically about the configurations for facets of the generative AI system within the branding/image class. When users make selections on this dashboard, the prompt manager 142 generates prompts that align with these user preferences and outputs tailored prompts matching the selections.

The prompt database 144 is a repository where prompts that can be used by the system are stored. These prompts are organized into sets, with each set being associated with a specific controllable facet accessible through the dashboard. Building upon the previous example, the prompt database 144 would have four distinct sets, each set linked to a particular facet: formality, tone, vocabulary, and sentence structure of the branding/image class.

In the formality facet set, for instance, the database holds a series of prompts that correspond to different positions of the formality slider on the dashboard. If the slider allows for five different positions, the set will contain five prompts, each associated with a specific position of the slider. These prompts are crafted to guide the LLM's response towards the desired level of formality.

Similar to the formality facet set, the tone, vocabulary, and sentence structure facet sets also contain prompts tailored to the corresponding controllable facets.

In an alternative illustration, the elements of tone, vocabulary, and sentence structure can be integrated into simpler user-friendly options, potentially enhancing user engagement by obviating the challenge of simultaneously fine-tuning the interconnected aspects of tone, vocabulary, and sentence structure. An example of such a harmonized approach entails providing the user with a range of terminological preferences that the Generative AI system can adopt. Presented below are exemplars of terminological choices that may be imparted as instructions to the Generative AI system:
1. Formal Terminology: Use formal language suitable for academic, business, or professional settings.
2. Informal Terminology: Utilize casual language suitable for everyday conversations.
3. Technical Terminology: Incorporate specialized jargon or technical terms relevant to a specific field or industry.
4. Scientific Terminology: Employ scientific language and terminology when discussing scientific topics or principles.
5. Medical Terminology: Use medical jargon and terminology for discussions related to healthcare and medicine.
6. Legal Terminology: Apply legal language and terms for discussions involving legal matters and contracts.
7. Slang and Colloquialisms: Integrate slang and colloquial expressions to create a more conversational and relatable tone.
8. Literary Language: Craft responses with literary devices and styles, such as metaphors, similes, and poetic language.
9. Historical Language: Mimic the language and style of a particular historical era or time period.
10. Futuristic Language: Create responses that sound futuristic or technologically advanced, suitable for sci-fi or speculative contexts.
11. Business Jargon: Use business-specific terms and phrases for discussions related to commerce and entrepreneurship.
12. Academic Language: Adopt the language typically used in academic papers and research articles.
13. Cultural Language: Incorporate language and references specific to a particular culture or subculture.
14. Concise Language: Respond using minimal and succinct language, suitable for brief and to-the-point answers.
15. Verbose Language: Provide detailed and lengthy explanations using an expansive vocabulary.
16. Emotive Language: Infuse responses with emotional language to convey feelings and sentiments.
17. Objective Language: Maintain an objective and neutral tone in responses, devoid of emotional influence.
18. Humorous Language: Use humor, puns, or witty remarks to create lighthearted and entertaining responses.
19. Inclusive Language: Ensure responses are inclusive and respectful of diversity and various perspectives.
20. Diplomatic Language: Employ diplomatic and tactful language when discussing sensitive or controversial topics.
21. Narrative Style: Craft responses in a storytelling format, with a clear beginning, middle, and end.
22. Technical Description: Provide detailed technical descriptions or explanations for complex concepts.
23. User-Friendly Language: Simplify explanations and use plain language to make complex topics more accessible.
24. Elevated Language: Use elevated language that conveys sophistication and refinement.
25. Casual Conversation: Respond as if engaged in casual conversation with a friend or acquaintance.

These are just a few examples of the many terminologies and styles that a generative AI system can be instructed to use in its responses. The choice of terminology depends on the context, audience, and desired tone of the communication.

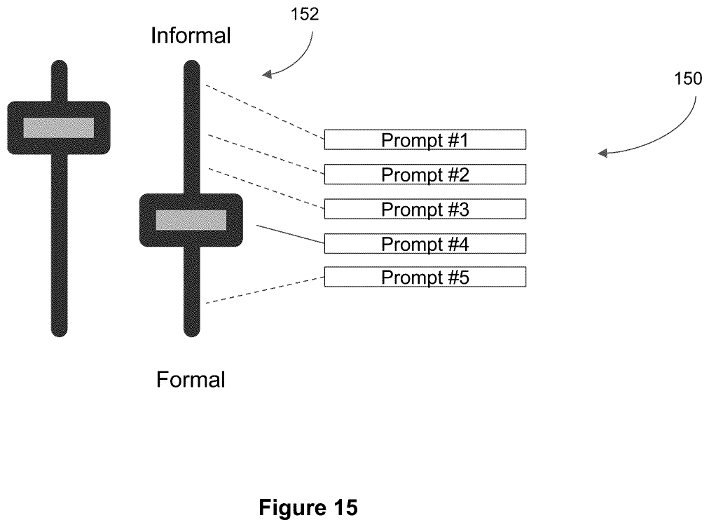

FIG. 15 visually illustrates the structure of the prompt database and its conceptual linkages with the graphical user interface (GUI) control. This diagram shows how the prompts within each set are related to the dashboard controls, enabling users to select and adjust the desired settings for each facet. These prompt sets, in conjunction with the GUI controls, provide users with a convenient and intuitive way to shape the behavior and output of the LLM according to their preferences. Specifically, the prompt database stores the set of prompt templates 150, which relate to the formality facet of the branding/image class. There are 5 individual prompts in the set, where each prompt is related to a particular position of the slider 152. The current position of the slider points to prompt #4, in other words if the slider is in that position, prompt #4 will be processed by the LLM. The other possible positions of the slider are related to corresponding prompts via dashed lines. So, if the output of the LLM model is desired to be informal, the slider 152 on the dashboard is moved to the top position and as a result the prompt #1 will be used. Conversely, if the output is to be formal then the slider 152 is moved completely down, which will implement the prompt #5. Prompts #2-#4 correspond to slider positions between the most informal level and the most formal level.

The reader will appreciate that the same relationships are provided between the sets of prompts associated with different facets and the respective slider controls. In the case of the harmonized approach where the user selects the style of terminology, generally the same approach applies. In this instance the visual GUI control may be different and use individually selectable options, such as check-boxes to identify a particular terminology style among a range of terminology styles.

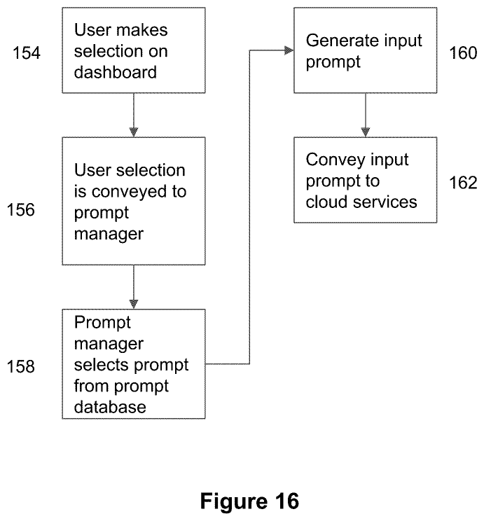

The flowchart in FIG. 16 illustrates the process performed by the prompt manager 142 and other components. At act 154, the user makes a selection on the dashboard. Again, taking the example of the formality facet, the user selection involves moving the slider or other type of GUI control from one position to another position. The control position is encoded and sent to the prompt manager 142, at act 156.

During the process at act 158, the prompt manager 142 retrieves the appropriate prompt that aligns with the user's selection. To achieve this, the prompt manager 142 utilizes the prompt database 144, which is organized and indexed based on the encoding of the GUI controls that allows matching prompts with the selected control settings.

At act 160, the prompt manager 142 generates the input prompt that will be submitted to the LLM. Referring back to FIG. 4, recall that the input prompt is a combination of both the system prompt (embedded prompt) and the end-user prompt. In this context, the prompt extracted from the prompt database constitutes the system prompt or forms a component of the system prompt. The prompt manager 142 has the ability to augment the prompt extracted from the prompt database 144 by adding additional prompts to create a comprehensive system prompt set. By doing so, it becomes possible to control multiple facets of the LLM's output simultaneously. This allows for a more nuanced and fine-grained influence over the LLM's behavior and enables users to shape various aspects of the generated responses by constructing a complete system prompt.

In summary, the prompt manager 142 retrieves the suitable prompt from the prompt database 144 based on the user's selection, and then optionally combines it with other prompts to form the input prompt.

In a practical implementation, the prompts stored in the prompt database 144 are crafted with the assistance of human evaluators. This process involves iterative refinement to achieve the desired gradation in the effect on the corresponding facet. To illustrate this, let's consider the formality facet once again.

To establish a spectrum of formality within the prompt database, multiple prompt examples are initially composed by a human evaluator. These prompts are then fed to the LLM, which generates outputs that reflect varying degrees of formality. The human evaluator then analyzes these outputs to assess if they align with the desired level of formality.

If the generated output does not meet the intended formality effect, the prompts are adjusted and resubmitted to the LLM. This iterative feedback loop is repeated until the desired result is achieved. Through this trial-and-error process, the evaluator continuously fine-tunes the prompts to elicit responses that exhibit the desired respective levels of formality.

Once a prompt successfully yields the desired degree of formality, it is assigned to the corresponding position in the prompt database 144. Specifically, the prompt which elicits the most formal output would be associated with the most formal setting of the GUI control. The prompt that produces the least formal output will be associated with the most informal setting of the control, and so on. This ensures that the prompt aligns with the intended control setting and will be retrieved when that specific formality level is selected.

Note that the prompt database 144, as previously described, is specific to an individual LLM. This means that prompts that effectively regulate the formality of output for a particular LLM may not yield comparable results or may not function at all for another LLM with distinct training data, parameter configurations, or other factors.

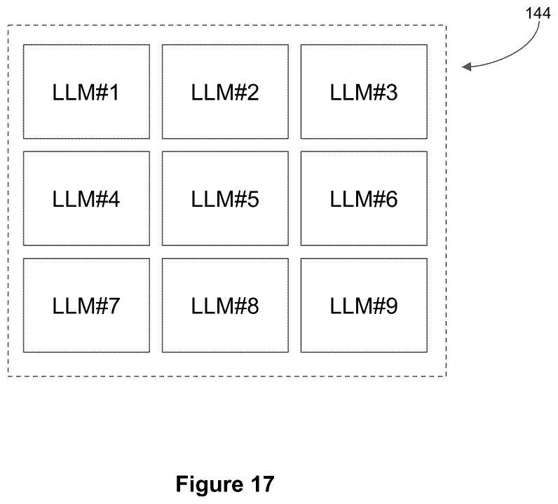

To accommodate practical implementations where the prompt database 144 serves multiple LLMs, a structured approach is adopted. In this implementation, the prompt database 144 is designed to allocate a distinct set of prompts for each LLM. This configuration is depicted in FIG. 17, where individual LLMs are assigned dedicated memory areas within the prompt database 144 to store their respective prompts.

To retrieve a specific prompt, the prompt retrieval operation necessitates not only the position of the GUI control but also the identification of the corresponding LLM being employed. This additional information is useful to identify the correct memory space within the prompt database 144 associated with the identified LLM. Subsequently, the desired prompt can be extracted from the appropriate LLM memory space during the retrieval process performed at act 158.

By incorporating LLM identification, alongside the GUI control position, the retrieval operation at act 158 can correctly identify the relevant LLM memory space within the prompt database 144.

This structured implementation allows for the prompt database 144 to effectively serve multiple LLMs, maintaining the necessary segregation of prompts and enabling precise retrieval based on LLM identification.

An alternative approach involves configuring the prompt database 144 to store bundles of prompts associated with multiple facets of the LLM's output. By applying these bundled prompts, the LLM's output is influenced across all the associated facets simultaneously. This approach is advantageous when the facets are interrelated, such that a change in one facet is likely to impact another facet. A notable example is the interplay between the formality facet and the tone facet.

Although formality and tone are distinct aspects of the LLM's output, they exhibit a certain level of correlation. For instance, a prompt designed to set the output tone as highly formal is likely to also induce a decreased degree of emotional content in the tone. In this scenario, utilizing a bundle of prompts would be beneficial, as the prompts within the bundle work in a coordinated manner to bring about cohesive and complementary changes to the LLM's output.

By employing a bundle of prompts, the modifications made to the related facets produce more harmonized and aligned adjustments in behavior. This approach ensures that the changes across facets are synchronized and less likely to create conflicting or contradictory effects. Bundling prompts enables a more nuanced control over the LLM's output, aligning with the desired output behavior by considering the interconnectedness of related facets.

For instance, the bundled prompts can include instructions to: (1) increase formality, which affects the formality facet, and (2) decrease the emotional content which affects tone. These prompts work together to guide the LLM in generating output that maintains a consistent tone, while also exhibiting the desired level of formality. The coordinated adjustments provide a more coherent and contextually appropriate output, enhancing the overall performance and alignment with user expectations.

In summary, utilizing bundles of prompts in the prompt database is a valuable strategy, particularly for related facets where changes in one facet are likely to affect other facets. This approach promotes more coordinated and synchronized modifications, ensuring a cohesive output that aligns with the desired behavior and maintains the desired relationship between interconnected facets.

In this particular example, a modification has been introduced to the functionality of the GUI controls on the dashboard, where the controls on which settings can be dialed in are no longer independent. Instead, a synchronized relationship among the controls has been established, wherein changes made to one setting automatically trigger corresponding adjustments to the settings of related facets.

For illustration, let's consider the interaction between the formality facet and the tone facet. When the user decides to modify the formality facet towards a more formal output, the dashboard manager 140 orchestrates an automatic adjustment to the tone facet's setting, aiming to reduce the degree of emotional content in the generated output. This integrated behavior ensures that changes made to one control result in coherent and complementary adjustments to the related control settings.

To facilitate this coordinated behavior, the dashboard manager 140 incorporates a functionality specifically designed to establish a functional mapping between the settings of overlapping facets. By doing so, the facet settings move in a synchronized and coordinated fashion, ensuring a cohesive setting adjustment. This functional mapping allows modifications applied to one control to yield contextually appropriate changes, to the corresponding settings of related controls.

The aforementioned examples are contextualized within scenarios where the prompt settings are employed as global settings, encompassing facets of operation for a broad user population within the generative AI system. These prompts, derived from the prompt database 140, serve as consistent system prompts that are uniformly embedded for a wide range of different users.

While this approach holds merit in terms of maintaining a consistent and unified experience for all users, it is worth considering the potential advantages of incorporating a dynamic prompt adaptation mechanism. Such a mechanism would account for specific use-cases, catering to individual user needs or particular situations that may necessitate tailored prompt configurations.

Integrating dynamic prompt adaptation acknowledges the diversity of user requirements and acknowledges the potential benefits of customization. By flexibly adapting prompts based on individual circumstances, the generative AI system can provide more personalized and contextually relevant outputs.

In conclusion, while the global prompt settings offer the advantage of brand coherence across the user population, there is value in exploring the implementation of a dynamic prompt adaptation mechanism. This allows the generative AI system to address individual user needs and contextual variations, thereby enhancing the user experience and facilitating greater alignment between the system's outputs and specific use-case requirements.

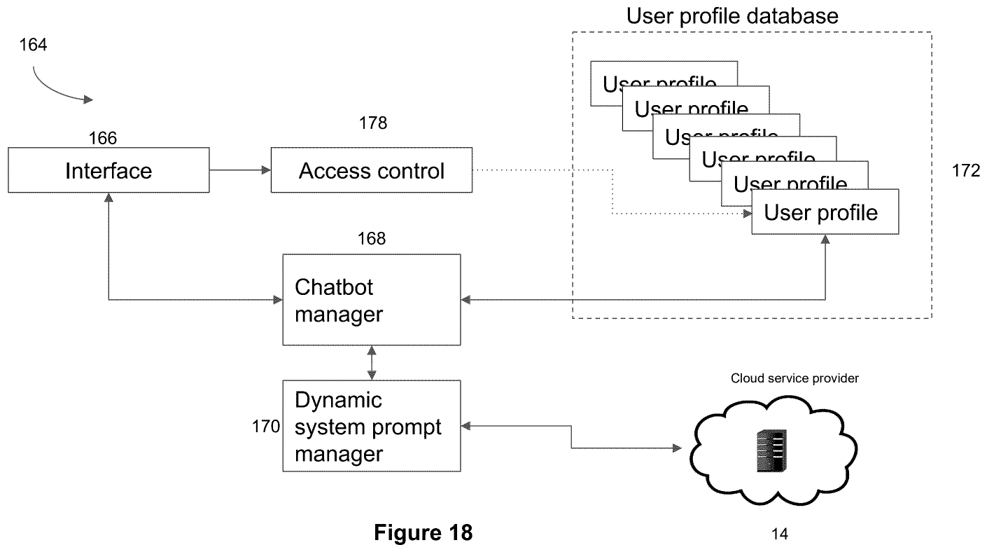

In a first example of dynamic system prompt adaptation, the prompt is adapted based on user profile. In this example, at least some component of the system prompt is user-specific such as to tailor the generative AI system output toward a behavior that is adapted to a particular user needs or desires, which are different from the needs of another user. An example of an architecture which implements a dynamic system prompt based on user profile is shown at FIG. 18, which is a block diagram of a computer-based system providing online services to users and which provides an LLM functionality. In one example, the services can be financial services where a user interacts with an LLM powered chatbot to obtain finance related information.

The chatbot system depicted in FIG. 18 is globally denoted as system 164. It comprises an interface 166 that facilitates user interactions with various software components and functionalities within the system 164. One instance of such user interaction is through a web browser, wherein the web browser assumes the role of implementing the interface 166's functionality.

The interface 166 serves as the conduit for user interactions with the chatbot, directing these interactions to a chatbot manager 168. In this particular scenario, the chatbot relies on a generative AI system implemented as a cloud-based service. Consequently, the chatbot manager 168 establishes communication with the cloud-based service 14. The chatbot manager 168 is responsible for constructing input prompts from system prompts and user prompts, submitting requests to the cloud-based service which include the constructed input prompts, receiving responses that encompass the material generated by the generative AI system to the input prompts, and ultimately directing these responses to the user via the user interface 166.

In summary, the system's components and functions are organized to enable user engagement through the interface 166, with the chatbot manager 168 acting as an intermediary between the interface and the cloud-based service hosting the generative AI system.

The system 164 also includes a dynamic prompt manager 170 that communicates with the chatbot manager. At a high level, the function of the dynamic prompt manager is to generate system prompts, which are user specific. The dynamic prompt manager 170 communicates with a user profile database 172. The user profile database stores a plurality of user profiles.

Generally, the user profile is a memory location that stores information with relation to a particular user allowing the system 164 to provide services which are tailored and specific to the particular user.

In the general context of an online account, a user profile refers to a collection of personal information and account-related data associated with a specific individual who has registered and created an account on a website or online platform. It serves as a digital identity and contains various details that help personalize the user's experience and facilitate their interactions with the online service.

A user profile in the context of an online account typically includes:

Personal Information: Basic details such as name, email address, date of birth, and contact information.

Username and Password: Unique credentials used for account login and authentication.

Account Preferences: Customized settings and preferences chosen by the user, such as language, time zone, or theme.

Activity History: Records of the user's interactions and activities within the online platform, including login history, purchases, searches, and comments.

Privacy Settings: Options to control the visibility of certain information or restrict access to specific features.

Communication Preferences: User-defined choices regarding email notifications, marketing communications, and opt-in preferences.

Social Media Integration: If applicable, connections to social media accounts used for logging in or sharing content.

Security Settings: Information related to security measures, two-factor authentication, and recovery options.

In the more specific context of the delivery of online financial services, a user profile also refers to a comprehensive and secure collection of financial data, personal information, and transaction history associated with an individual user or customer. It is a digital representation of the user's financial identity and activities within the online financial platform or service.

A user profile in online financial services typically includes: Personal Information: Basic details such as name, address, contact information, date of birth, and identification documents.

Account Information: Details about the user's financial accounts held within the online service, including bank accounts, credit cards, investments, and loans.

Transaction History: A record of the user's financial transactions, such as deposits, withdrawals, transfers, and payments.

Credit History: Information on the user's creditworthiness, credit score, and credit-related activities.

Security Settings: Data related to the user's authentication methods, passwords, and security preferences to protect their financial information.

Preferences and Alerts: User-defined settings for account notifications, transaction alerts, and communication preferences.

Financial Goals: Information about the user's financial objectives, such as savings targets or investment goals.

Investment Portfolio: Details of the user's investment holdings, performance, and asset allocation.

Budgeting and Spending Habits: Information on the user's budgeting strategies, spending patterns, and financial habits.

Regulatory and Compliance Data: Data required for compliance with legal and regulatory obligations, such as anti-money laundering (AML) and know-your-customer (KYC) information.

In addition to the aforementioned details, a user profile within the user profile database further includes system prompt information aimed at configuring the chatbot's behavior to tailor its output according to the user's preferences. This system prompt information, stored in the user profile, exerts influence on the behavior of the generative AI system with respect to any of the facets previously described. Moreover, the system prompt information may encompass other user-related data, thereby further customizing the output of the generative AI system.

For instance, the system prompt information can incorporate the user's name, allowing the generative AI system to address the user by their username during chatbot interactions. Furthermore, the system prompt may include account information, enabling the generative AI system to conduct account processing and furnish financial analysis insights to the user. An illustrative case entails integrating the user's stock portfolio into the system prompt, facilitating the retrieval of individual stock values and the overall portfolio's balance. These details are then presented to the user at the outset of the chatbot conversation, obviating the need for the user to explicitly inquire about their portfolio's balance.

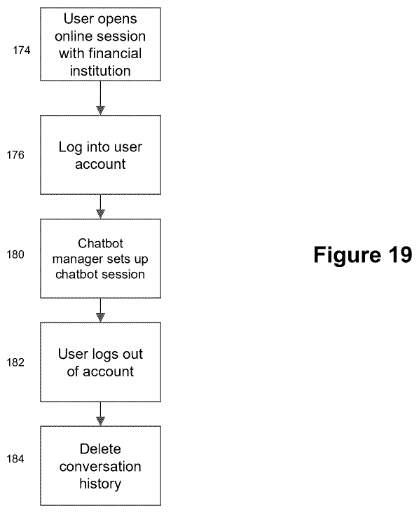

The process flow will be described in greater detail in relation to the flowchart shown in FIG. 19. At act 174, the user opens an online session with the financial institution. At act 176, the user logs into its account by providing user credentials or by any other method allowing the system 164 to verify the user identity, via the access control module 178 shown at FIG. 18. At act 180, the chatbot manager 168 sets up a chatbot session such that the chatbot is ready to respond to inquiries from the user.

Act 180 includes generating system prompt information, which could be integrated along with a user prompt into an input prompt that is submitted to the chatbot to elicit a response. The system prompt information is generated by the dynamic system prompt manager 170 which accesses the user profile in the user profile database 172. Note that access control is managed via the access control module 178, such that only the user profile that has been unlocked and which is the one corresponding to the user is available to the dynamic system prompt manager 170.

The dynamic system prompt manager 170 extracts from the user profile information to assemble a system prompt. That information includes prompt-specific information, which has no use other than in the context of a system prompt. For example, the prompt specific information can include settings of facets in the branding/image class. That particular user may desire an informal tone and a simple vocabulary structure than a more formal tone. In addition to the prompt specific information stored in the user profile, the prompt manager 170 can optionally retrieve other information from the user profile which is not prompt specific. For example, that other information includes personal information, such as name, address, contact information, account information, transaction history, financial goals, investment portfolio and budgeting and spending habits, among others.

The prompt specific information and the other information extracted from the user profile is processed by the dynamic system prompt manager 170 to build a system prompt. In addition to the information obtained from the user profile the dynamic system prompt manager may also include in the system prompt additional prompt-related information, which is global and affects all users.

The dynamic system prompt manager 170 outputs the system prompt to the chatbot manager 168. In one possible form of implementation, the chatbot manager 168 sends the system prompt to the generative AI system to elicit a welcome message which is user specific, before the user has asked a question.

The message could be something along the lines of:
“Good morning Mr. Doe,
Good news! Your investment portfolio is trending up which follows the rise of the broader market. The value of your portfolio is up by 0.3% since yesterday and now has a balance of $X. In your portfolio, the stock value of company Y has seen the largest increase and now trades at $Z per share.
Please let me know what I can do for you today.”

Alternatively, the chatbot manager 168 remains silent until the user explicitly asks a question. In this case the chatbot manager uses the system prompt as generated by the dynamic system prompt manager 170 and appends to it the question asked by the user, to build the input prompt that is submitted to the generative AI system.

The conversation with the chatbot continues until the user has received the necessary information.

At act 182, the user initiates the logout process from the online account, which can occur explicitly through the user's action of interacting with a graphical user interface (GUI) control to sign out or implicitly through an automated time-out mechanism following a period of user inactivity.

At act 184, the chatbot manager undertakes the task of ensuring data privacy and security by deleting the conversation history with the generative AI system. This deletion is done to prevent any inadvertent re-utilization or disclosure of sensitive user information during subsequent conversations with different users. To accomplish this, the prompt manager feeds a prompt to the LLM explicitly requesting the deletion of the conversation history and the resetting of all conversation parameters to their initial state. Optionally, the chatbot manager 168 locks the LLM from further client engagement unless a confirmation has been received from the LLM that the conversation history has been deleted.

The process of purging the conversation history is useful in maintaining confidentiality and upholding data protection principles within the online environment.

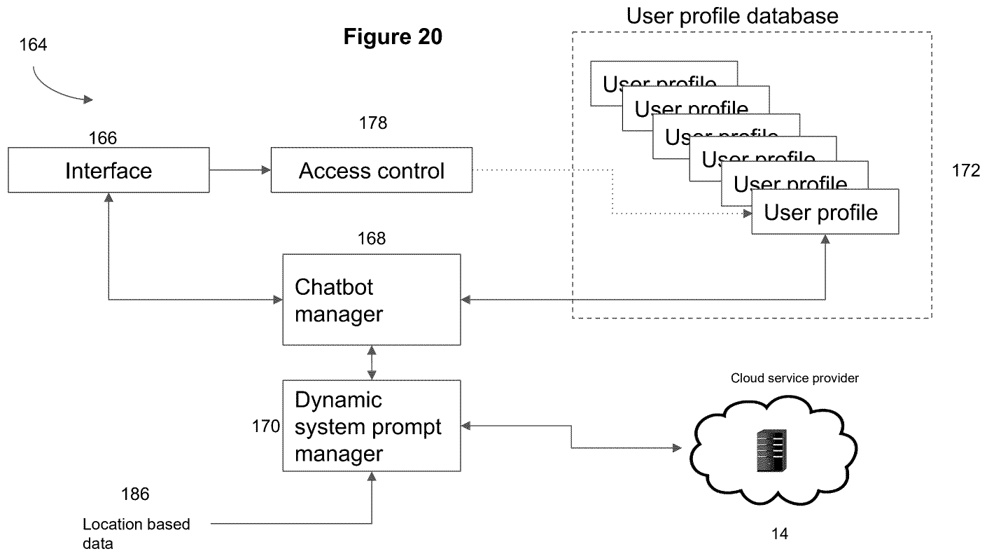

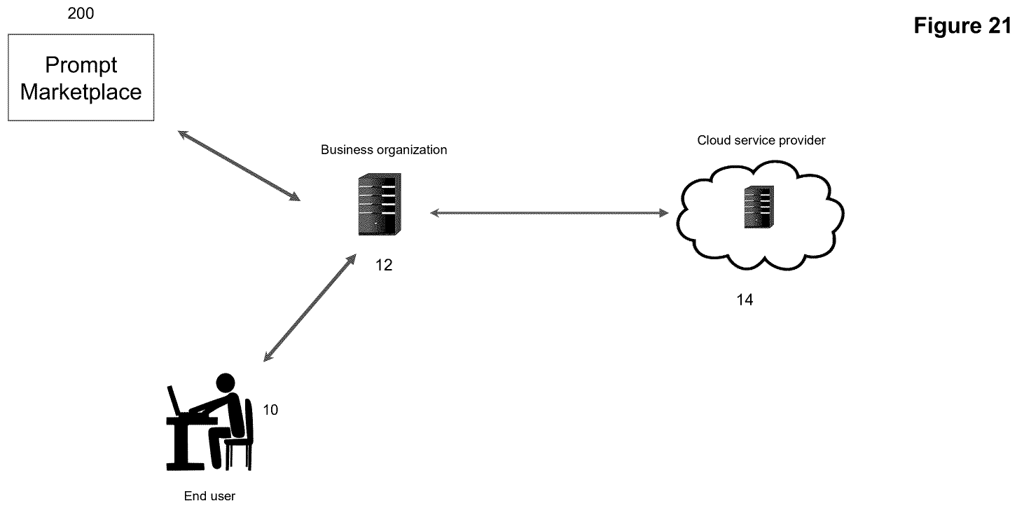

FIG. 20 is a block diagram of a variant of the system depicted in FIG. 18, where the prompt is augmented with location-based information. Location-based data is input to the dynamic system prompt manager and the system prompt is conditioned on this location-based information.

In a given instance, geospatial data conveys the location of an end-user. This spatial delineation can be derived from the user's IP address or through alternative methodologies. Such alternative techniques encompass the identification of the cellular network and in particular the cellular tower to which the user's mobile device is connected, the Global Positioning System (GPS) coordinates generated by said mobile device and subsequently integrated into the communication protocol, among potential other methods.

The procurement of the location data can enhance the interaction with the LLM as it anticipates the contextual requirements for a more tailored conversation. For illustrative purposes, should an end-user inquire about the monetary valuation of a product or service, which is contingent upon the user location, pre-existing knowledge of said location and its subsequent integration into the system's prompt will furnish the LLM with the necessary context. Consequently, the response generated by the LLM is more likely to align with the end-user's specific needs and expectations.

Note that the location-based information can be directly integrated into the system prompt to provide context for the LLM. This can be achieved by directly specifying the end user's location in the prompt. Furthermore, the location-based data can be used to influence the behavior of the LLM in various other ways. For instance, the data can serve as a factor in adjusting a modifiable facet of the LLM's output, such as the choice of the system prompt that will be submitted to the LLM.

For instance, the dynamic prompt manager 170 includes logic designed to receive the location-based data as an input and command in response to the location-based data changes to certain facets of the LLM. Those modifiable facets relating to branding/image. In one form of implementation, the logic is configured to map locations to formality or tone settings such that at a certain location the formality and or tone of the LLM will change. In this form of implementation, the location-based data is not directly placed into the prompt, but it is used as a factor in the selection of the system prompt that will be input in the LLM to condition the LLM behavior.

In another example, the location-based data is supplemented or substituted by time and/or date information. “Time and/or date information” typically refers to the specification or determination of a particular occurrence, event, or action based on a designated time or date. This means that certain activities or decisions are made contingent upon a specific temporal marker.

In a manner akin to location-based data, incorporating a priori knowledge of time and/or date through a system prompt can furnish the Language Model (LLM) with supplementary context, enhancing the relevance of its output for the user. This temporal information may be directly included within the system prompt or alternatively utilized to influence modifiable aspects of the LLM's behavior.

One practical application involves leveraging the time and/or date details to condition the LLM's responses in accordance with specific occasions, such as the holiday season. For example, the dynamic prompt manager 170 would select in response to the time and/or date data a suitable prompt that greets the user with New Year wishes at the beginning of the year, aligning the LLM's output with the festive context.

### Prompts as Digital Products and Platform to Control the Sale and Distribution of Prompts

As previously discussed, prompts serve as input vectors that initialize and direct the operational dynamics of a Generative Artificial Intelligence (AI) system, thereby controlling the AI-generated outputs. While prompts are typically custom-crafted to cater to the unique requirements of distinct use cases, they can also be repurposed across diverse user cohorts.

The extensible nature of prompts applies particularly to system prompts, which function as contextualizing cues for the underlying Language Model (LM). System prompts possess the inherent capacity to be architected in such a manner that they can accommodate a spectrum of applications characterized by shared ontological attributes. This versatility enables the development of system prompts that encapsulate the thematic commonalities prevalent within a given domain, such as specific image or branding behaviors, thereby affording the Generative AI system the ability to swiftly adapt and generate contextually congruent outputs across an array of related tasks.

In the realm of Generative AI systems, particularly in the context of system prompts, these prompts serve as digital commodities that hold the potential for commercialization and dissemination across various applications and user segments. Consequently, there is a need in the industry for a digital platform aimed at streamlining the processes associated with the distribution and commercial transactions of such prompts to end users.

FIG. 20 illustrates a schematic representation of a computer-implemented architecture, specifically a digital marketplace designed for system prompts, particularly those intended to modulate the operational characteristics of Generative AI systems. In the illustrated implementation scenario presented in FIG. 20, the digital marketplace denoted as “200” is portrayed as an autonomous node within a data network, such as the Internet. This entity engages in interactions with other entities while interfacing with the cloud-based service instantiation 14 of a Generative AI system.

In this implementation example, the business organization 12 which uses the cloud-based Generative AI system 14, either for internal business purposes or for external purposes, such as to provide Generative AI assistance during the delivery of products or services to clients communicates with the digital prompt marketplace 200 to obtain from the marketplace system prompts that are adapted to the needs of the business organization. In particular, the business organization may wish to tailor the behavior of the Generative AI system 14 such as to project a certain brand or image to users of the Generative AI system, which can be achieved through prompt engineering. In this instance, the IT manager of the business organization 12 would access the digital marketplace 200, which acts as a repository or catalogue of system prompts applicable to a range of different business uses, identify the system prompt that meet the needs of the business organization 12, download the prompt in exchange for payment and implement it at the business organization 12. As it will be discussed in greater detail later, the implementation step includes using the downloaded system prompt to perform prompt embedding to set the context of operation of the Generative AI system.

Note that the downloaded system prompt component may be combined with other system prompt components to build a final system prompt which is presented to the Generative AI system. In other words, the downloaded system prompt from the prompt marketplace 200 is not necessarily the final system prompt that the Generative AI system 16 sees. For example, the system prompt component downloaded can be combined with a system prompt component extracted from the user profile to develop a system prompt which achieves a certain brand/image in addition to providing a user-specific context to the Generative AI system.

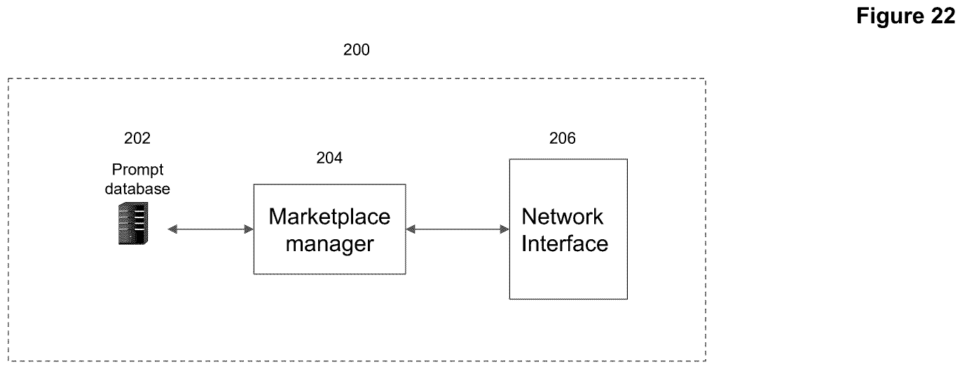

FIG. 22 illustrates a block diagram that provides a more granular representation of the prompt marketplace's architectural framework 200. Within this construct, the prompt marketplace includes a prompt database, referred to as “202.” This database serves as a comprehensive prompt repository, housing a collection of discrete prompt components curated for utilization as integral elements of system prompts.

These individual prompt components are stored as discrete digital products within the database, and their accessibility is enhanced through a catalog that employs a property-based search mechanism via metadata attributes. The metadata attributes allow users to perform catalog searches using keywords or any other suitable method of search.

An optional encryption mechanism is implemented to protect the prompt data. To facilitate the decryption process and enable access for duly licensed users, a dedicated licensing functionality is integrated, as it will be discussed below.

The marketplace manager 204 denotes the software implemented functionality which performs the overall management and control of the prompt marketplace 200. Specifically, the marketplace manager 204 manages end-user interactions, database 202 interactions and manages the data encryption/decryption process to make the digital prompt products available to licensed end-users.

For completion, FIG. 22 also shows a network interface 206 through which incoming and outgoing messages to the marketplace manager 204 are channeled.

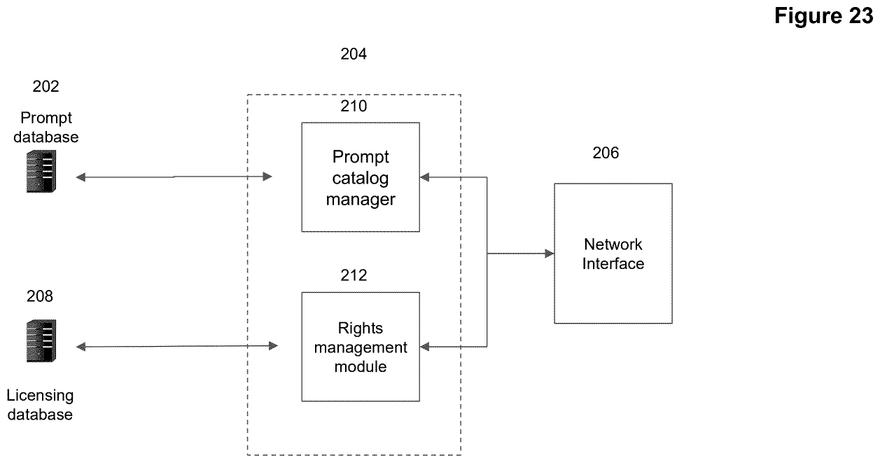

FIG. 23 is a high-level block diagram showing the architecture of the marketplace manager 204. The marketplace manager 204 includes two main functional blocks, namely the prompt catalog manager 210 and the Digital Rights Management (DRM) module 212.

The prompt catalog manager, denoted as “210,” manages interactions between end-users seeking to consult the catalog for the purpose of identifying system prompts of interest. To be more specific, the prompt catalog manager 210 is configured to implement a Graphical User Interface (GUI) on the end-user computer designed to enable the user with the ability to initiate a search query. This search query can take visual or textual form, enabling the end-user to articulate their criteria for system prompt identification.

The GUI incorporates a set of visual controls that allow the end-user to input requisite information for the system's catalog search algorithm to identify matching system prompts. One such visual control includes a text box, serving as an interface through which the user can input a series of search terms. These terms may align with various facets of industry segmentation. For example, the user might input terms like “finance,” “accounting,” “retail business,” “service business,” “religious institution,” and the like.

Alternatively, the visual control may offer a predefined list of industries presented in a menu format, affording the end-user the convenience of selecting from predetermined options. This menu can be hierarchically structured, such that the user begins by choosing a general industry sector, subsequently prompting them to make further, more specific category selections. This hierarchical approach streamlines the search process.

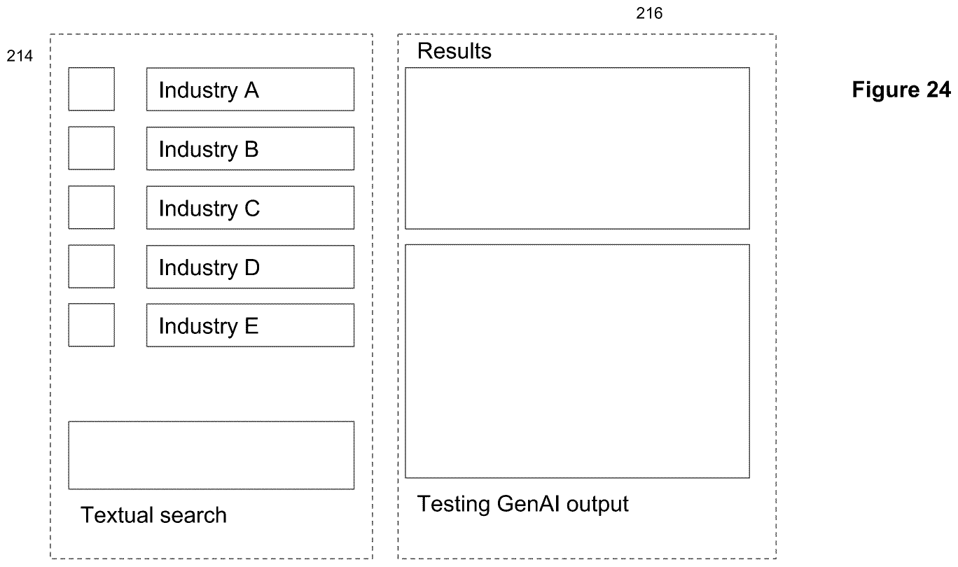

FIG. 24 is an example of a Graphical User Interface (GUI) showing diverse control elements, designed to facilitate end-user interaction for the purpose of querying the prompts catalog. Management of this GUI is provided by the prompt catalog manager 210. In a practical application, the prompt manager 210 implements the GUI through a web browser interface.

The GUI has a bifurcated structure, featuring two principal delineations: the input section, labeled as 214, and the output section, identified as 216. The input section 214 is architected to accommodate dual input modalities, thereby enhancing user-driven query capabilities.

The first input modality is characterized by discrete, opt-in selections embodied as checkboxes. In this instantiation, these checkboxes are linked to various industry sectors, encompassing domains such as legal, medical, technical, retail, and the like. As previously stated, a hierarchy framework can be instantiated to augment the granularity of the search functionality.

For instance, upon the user's selection of a particular industry sector through a checkbox, the visual control dynamically expands, providing supplementary layers of choices, thus allowing the user to further delineate and refine their search criteria. By way of illustration, the selection of the “medical” category triggers the presentation of a cascading menu, thereby providing additional sub-options nested within the overarching “medical” classification, covering facets such as dentistry, plastic surgery, and analogous specialties.

The second input modality includes a natural language input box, where the user can provide a list of keywords. An example of a keyword sequence may include: “medical industry, dentistry”.

Output section 216 serves as the means for transmitting the outcomes of the catalog search to the end-user. This output section presents an inventory, displayed in list format or otherwise, of the system prompt components from the catalog, aligning with the prescribed search criteria.

In a particular instance, the end-user may make a selection of a given prompt component from the list, thereby triggering a request for additional information of its attributes. This supplementary information pertaining to the chosen component is then presented within a distinct interface window, the activation of which is prompted upon the end-user's selection of said prompt component.

This supplementary information may encompass particulars of the utilization of the selected prompt component, pricing, and an enhanced delineation of its applications.

Within the scope of output section 216, an additional component termed the “testing area,” is provided allowing end-users to directly evaluate selected prompts while observing the responses generated by the Generative AI system under different user prompts. This testing area has a test input box, which serves as the interface enabling the end-user to input distinct user prompts, thereby invoking the Generative AI system to furnish a corresponding output.

The operational context of the Generative AI system is established by applying a system prompt that the user has selected from the inventory of available system prompts. Through the selection of a particular system prompt, the end-user sets the context within which the Generative AI system operates. The end-user is allowed to conduct iterative testing operations, on the entire spectrum of system prompts listed in the inventory, for a comprehensive assessment of their appropriateness in fulfilling the user's specific needs.

If the user identifies in the catalog a system prompt that satisfies the user, the user may purchase a license for using the prompt. The purchase operation is performed via the GUI using controls (not shown in the drawings) allowing the user to submit payment. Upon successful transaction, an entry is made in the licensing database 208 associating the identity of the user with the prompt, to indicate that the user has acquired rights to use the system prompt.

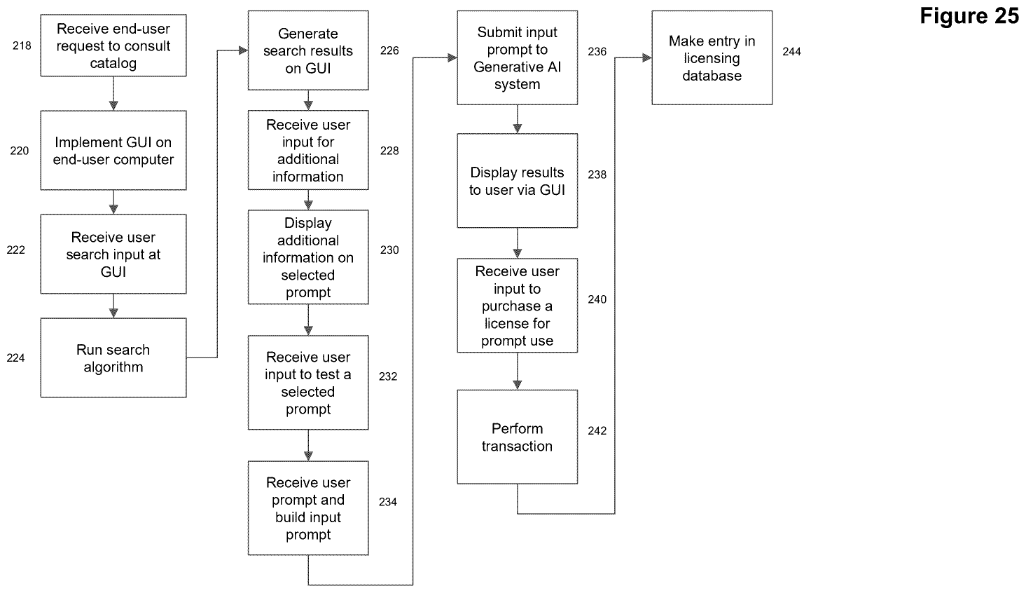

FIG. 25 is a flowchart that illustrates the various steps in the process for searching the catalog of prompts, testing selected prompts and eventually making a transaction to purchase a license for using one or more of the selected prompts. More specifically, at step 218 the prompts catalog manager 210 receives a request from an end user to consult the catalog. That request can be made by the user by accessing a web site hosting the marketplace manager. At step 220, the prompt catalog manager 210 that receives the request implements on the user computer, via a web browser or any other way, the GUI that provides the user with the tools to browse the catalog. At step 222, the user enters the search criteria via the GUI interface at the input section 214. The user can either select specific options presented on the interface or enter a textual description of what the user is interested in.

At step 224 the prompts catalog manager 210 runs a search algorithm to identify among the prompts stored in the database 202 those that match the search criteria. An effective strategy is to associate with the prompt metadata that provides a characterization of the prompt. The search algorithm is run on the metadata to identify prompts that match the search criteria. For instance, the metadata can include information about the industry sector for which the prompt is adequate, at the desired level of granularity. Alternatively, or in addition to the metadata can include keywords that are searched if a text string is entered by the user.

At step 226, the search results are presented to the user via the GUI. For instance, the search results, which typically would include an inventory of prompts that match the search criteria are listed on the GUI. The results can be ordered in the list in any desired fashion, such as by relevance.

At step 228, the user makes an input on the GUI to request more information on anyone of the listed prompts. The input can include a click on the prompt of interest using a pointing device or simply by letting the cursor hover over the prompt of interest. The prompts catalog manager 210 receives this input and provides additional information about the selected prompt. This additional information is extracted from the metadata associated with the prompt and is displayed on the GUI in a separate window at step 230.

In step 232 of the process, the prompts catalog manager 210 receives a user input via the GUI to initiate a sequence of test sessions, with a specific system prompt selected from the available list. This user input may encompass actions such as selecting a designated “Test” button presented within the GUI or any equivalent user-initiated command.

Upon receiving this input, as per step 234, the prompts catalog manager 210 further registers an additional input, which assumes the form of the user-generated prompt—a textual sequence denoting the instruction or query to be submitted for processing by the Generative AI system. This user-generated prompt encapsulates the specific informational requisites and objectives articulated by the end-user.

At step 236 the prompt catalog manager 210 composes the input prompt for submission to the Generative AI system. This input prompt involves the integration of two components: firstly, the user-generated prompt, which serves as the user's distinct input query or directive, and secondly, the system prompt, selected by the user to serve as the context-defining framework for the Generative AI system's operation.

During step 236 of the process, the composite input prompt is submitted to the Generative AI system with the aim of eliciting an output response. This resultant output is subsequently relayed to the end-user through the graphical interface (GUI) and displayed within the dedicated testing container integrated into the GUI layout. The end-user is thus given the opportunity to review the generated output and evaluate the Generative AI system's responsiveness as conditioned by the selected system prompt.

This evaluative process is designed to be iterative, permitting the end-user to execute the test multiple times in order to ascertain the appropriateness and efficacy of the prompts identified through the prior search process.

In the instance where the user is satisfied with the performance of any of the prompts selected by the search process, the user can purchase a license for using one or more of the prompts. This is shown at steps 240 and 242. After the transaction is completed, which typically includes payment by the user for the license, an entry is made in the licensing database to identify the user as a legitimate licensee.

The marketplace manager 204 also includes a rights management module 212. The function of this module revolves around the governance of licensed prompts, with a focus on streamlining the decryption process, thereby rendering these prompts accessible exclusively to duly authorized users in adherence to the stipulated licensing terms.

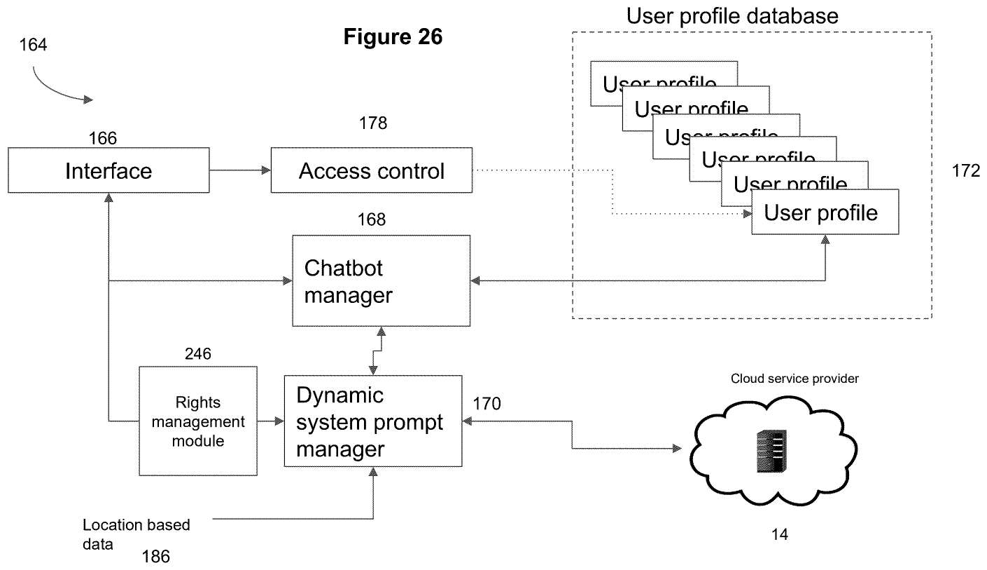

In one embodiment, a rights management module, denoted as 212, is configured to interface with an analogous rights management module, labeled 246, located within an end-user computing device as depicted in FIG. 26. It should be noted that FIG. 26 substantially mirrors the configuration illustrated in FIG. 20, save for the integration of the rights management module 246. Additionally, the rights management module 246 is communicatively coupled to the dynamic system prompt manager 170.

In a preferred embodiment, the rights management module 246 performs the decryption of system prompts, thereby rendering them operable within the system as illustrated in FIG. 26. Specifically, system prompts disseminated by the prompts marketplace 200 are stored and relayed in an encrypted format, allowing controlled utilization of said prompts. To facilitate these prompts' operability in conjunction with a Generative AI system, decryption is necessary. Prior to initiating decryption, a verification process ascertains the licensing status, ensuring that the end-user possesses the requisite permissions for prompt utilization. Upon positive verification, the prompt undergoes decryption.

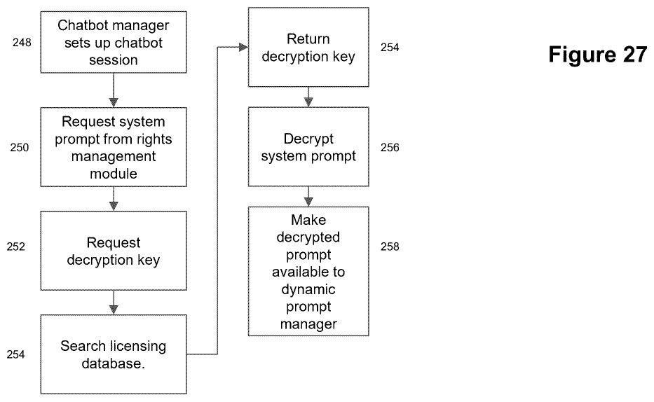

FIG. 27 is a flowchart of the process performed to decrypt a system prompt licensed from the prompt marketplace 200 and making the prompt ready for use in a Generative AI system. This example of the process is made in the context of a chatbot.

In one embodiment, the process initiates at step 248 wherein the chatbot manager 168, establishes a chatbot session facilitating an end-user to relay a query to the Generative AI system. The methodology encompassed in establishing the chatbot session encompasses the initialization of requisite system components, in particular readying the system prompt for execution. For illustrative purposes, it is assumed that a system prompt is procured from the marketplace manager 200. This particular system prompt sets the operational context for the Generative AI system subsequent to an end-user's query submission to the chatbot.

The system prompt is stored in an encrypted state. When the system prompt is needed by the dynamic system prompt manager 170, the latter makes a request to the rights management module 246 to deliver the system prompt in a decrypted state. This is illustrated at step 250 of the flowchart in FIG. 27.

At step 252 the rights management module 246 issues a request to the rights management module 212 of the prompts marketplace 200. The request conveys an identifier to allow the rights management module 212 to retrieve the correct entry in the licensing database 208 which is associated with the licensee, as shown at step 252. In a specific example, the entry in the licensing database contains data indicating the status of the license (active/inactive) and the decryption key. Assuming that the license is active, the rights management module 212 returns to the rights management module 246 the decryption key, as shown at step 254.

At step 256 the rights management module 246 decrypts the system prompt with the provided key and, at step 258 makes the decrypted system prompt available to the dynamic system prompt manager 170.

1. A computer system comprising one or computers and one or more data storage devices storing instructions, which when executed by the one or more computers implements a characterization manager, comprising:
a. a test data database storing a plurality of test data sets;
b. the characterization manager configured for selecting one or more test data sets from the test data database and apply the selected test data sets to a Generative AI system to derive from the Generative AI system an output;
c. an output analyzer for processing the output to generate characterization data describing one or more facets of the output.

2. A computer system as defined in claim 1, wherein the output analyzer is configured to compute a score indicative of a performance of the Generative AI system in relation to a certain metric.

3. A computer system as defined in claim 2, wherein the output analyzer is configured to compute a plurality of scores associated with respective facets of the output.

4. A computer system as defined in claim 3, wherein the output analyzer is configured to derive from the plurality of scores an aggregated score indicative of an overall performance of the output across the plurality of facets.

5. A computer system as defined in claim 3, wherein a facet among the plurality of facets is associated with accuracy of the output.

6. A computer system as defined in claim 3, wherein a facet among the plurality of facets is associated with clarity of the output.

7. A computer system as defined in claim 3, wherein a facet among the plurality of facets is associated with relevance of the output.

8. A computer system as defined in claim 3, wherein a facet among the plurality of facets is associated with policy compliance of the output.

9. A computer system as defined in claim 3, wherein a facet among the plurality of facets is associated with ethics and fairness of the output.

10. A computer system as defined in claim 3, wherein a facet among the plurality of facets is associated with security and privacy of the output.

11. A computer system as defined in claim 3, comprising a test data generator for dynamically generating test data to be submitted to the Generative AI system.

12. A computer system as defined in claim 3, wherein the characterization manager is responsive to a characterization request of the Generative AI system to be performed and performing the characterization process in accordance with the characterization request.

13. A computer system as defined in claim 12, wherein the characterization request describes one or more facets of the output of the Generative AI system to be characterized.

14. A computer system as defined in claim 13, wherein the characterization manager selects the one or more test data sets from the test database at least in part on the basis of the characterization request.

15. A computer system as defined in claim 12, wherein the characterization request conveys an identifier of an LLM model executed by the Generative AI system.

16. A system as defined in claim 15, wherein the request includes an API key associated with the LLM model.

17. A system as defined in claim 16, wherein the LLM model is hosted by a cloud service provider, the characterization manager submitting the API key via a network interface to interact with the LLM model and perform characterization of the Generative AI system implementing the LLM model.

18. A system as defined in claim 12, wherein the characterization manager is configured to implement at a remote computer a Graphical User Interface, allowing a user at the remote computer to input the characterization request via the GUI.

19. A system as defined in claim 18, wherein the GUI includes a plurality of graphical controls allowing the user to select one or more facets of the output of the Generative AI system to be characterized.

20. A system as defined in claim 19, wherein the GUI is configured to display a plurality of individually selectable facets of the output of the Generative AI system that can be characterized by the characterization manager.
